(19) United States
(12) Patent Application Publication
(10) Pub. No.: US 2015/0063113 A1
(43) Pub. Date: Mar. 5, 2015

(54) TRAFFIC CONTROL METHOD AND TRAFFIC CONTROL APPARATUS

(71) Applicant: HITACHI, LTD., Tokyo (JP)

(72) Inventors: Akihiko YOSHIDA, Tokyo (JP); Keiji USUBA, Tokyo (JP)

(21) Appl. No.: 14/476,806

(22) Filed: Sep. 4, 2014

(30) Foreign Application Priority Data
Sep. 5, 2013 (JP) 2013-183576

(51) Int. Cl. H04L 12/721

(52) U.S. Cl. CPC H04L 45/38
USPC 370/235

(57) ABSTRACT

The present invention is contrived to implement more granular traffic control and improve a traffic control method. A traffic control method disclosed herein performs the following: with respect to a plurality of terminals that connect to a network and perform communication via a communication link, analyzing signaling during a session performed by each terminal from a time when a terminal initially connects to the network, thereby associating a terminal, an application, and signaling required for the application; generating control information including identifiers for implementing traffic control on a per-signaling basis, based on preconfigured information on an object that should be under traffic control and the analysis results; assigning to a received packet an identifier on a per-signaling basis based on the control information; and referring to the identifiers and the control information and performing a specified traffic control action on signaling included in the packet.

### CLAIM OF PRIORITY

The present application claims priority from Japanese patent application serial no. 2013-183576, filed on Sep. 5, 2013, the content of which is hereby incorporated by reference into this application.

### BACKGROUND OF THE INVENTION

1. Field of the Invention

The present invention relates a control apparatus and a control method for controlling traffic.

2. Description of the Related Art

A traffic control apparatus of related art implements per-packet traffic control over a total number or a total amount of packets that are transmitted and received over a link, as described in, e.g., Japanese Published Unexamined Patent Application No. 2013-042475.

### SUMMARY OF THE INVENTION

As smart phones have come into popular use recently, a range of applications that can be developed for terminals broadens and a plurality of mobile communication operators and suppliers continue to develop a wide variety of applications. Among the wide variety of applications, there is an application that is arranged such that application products installed on user terminals start up simultaneously at a certain time and transmit and receive mobile communication signaling simultaneously. Such an application gives rise to a signaling burst that is unforeseeable by mobile communication operators and affects services for other end users and other applications, which becomes a problem.

The abovementioned traffic control apparatus of related art implements control according to a total number or a total amount of packets that are transmitted and received over a link, without being conscious of mobile communication signaling. Therefore, the traffic control apparatus of related art is unable to perform control, while identifying an application that is executed by an end user and an equipment type of a terminal that is used by an end user. Consequently, the traffic control apparatus of related art applies traffic control to not only signaling for an application that gives rise to a signaling burst, but also signaling produced by other applications, which affects overall end-user service quality.

The traffic control apparatus of related art implements per-packet traffic control. Therefore, in a case where one packet includes a plurality of pieces of signaling data, some of which are other than a kind of signaling that should be under traffic control, the traffic control apparatus of related art can only choose between performing traffic control on the packet data including signaling data that should not be under traffic control and not performing traffic control. In the case where one packet includes a plurality of pieces of signaling data and if traffic control is performed on the packet data including signaling data that should not be under traffic control, the traffic control is applied also to an application other than the application or the equipment type of a terminal that gives rise to a signaling burst and this affects end-user service quality. However, unless applying traffic control to the packet including a plurality of pieces of signaling data, the signaling burst cannot be controlled completely. This also affects end-user service quality.

As noted above, the traffic control apparatus of related art creates a situation where even signaling for which traffic control should not be performed is controlled or signaling for which traffic control should be performed is not controlled and poses a problem of affecting end-user service quality.

The present invention has been made to solve the above problem and is contrived to implement more granular traffic control and improve a traffic control method.

In order to solve the above problem and in accordance with an aspect of the present invention, by way of example, there is provided a traffic control apparatus including a packet analysis unit that analyzes a packet transmitted over a communication link, a packet control unit that performs packet processing or packet output control, and a traffic management unit that manages control information for controlling traffic. With respect to a plurality of terminals that connect to a network and perform communication via the communication link, the packet analysis unit analyzes signaling during a session performed by each terminal from a time when a terminal initially connects to the network, thereby associating a terminal, an application, and signaling required for the application, and transmits analysis results to the traffic management unit. The traffic management unit generates control information including identifiers for implementing traffic control on a per-signaling basis, based on preconfigured information on an object that should be under traffic control and analysis results. The packet analysis unit assigns to a received packet an identifier on a per-signaling basis based on the control information and transmits the packet to the packet control unit. The packet control unit refers to the identifiers and the control information and performs a specified traffic control action on signaling included in the packet.

More particularly, the packet control unit performs any of traffic control actions as follows: packet editing that controls traffic by changing data of signaling, which is specified signaling, within a packet; discarding signaling data in excess of a threshold value; control according to a packet transmission rate; and priority control based on priority information.

Also, more particularly, the traffic management unit performs statistical processing with regard to an amount of signaling occurrences by associating packet analysis results received from the packet analysis unit with temporal information, predicts signaling bursts to occur at random times or periodically, based on statistical processing results, and generates control information.

Also, more particularly, the packet analysis unit has a table mapping between each signaling process and an amount of load on a destination device to which a packet is transmitted for calculating an amount of load on the destination device to complete a signaling process on signaling data included in a packet, for each destination device. Upon receiving a packet, the packet analysis unit refers to the table and obtains an amount of load on a destination device for processing the packet, if transmitted to the destination device, and notifies the traffic management unit of the obtained amount of load. The traffic management unit generates control information based on the amount of load on the destination device.

According to the present invention, it is possible to implement more granular traffic control and improve a traffic control method.

### BRIEF DESCRIPTION OF THE DRAWINGS

Preferred embodiments of the present invention will now be described in conjunction with the accompanying drawings, in which;

FIG. 1 is a block diagram to explain a network architecture;

FIG. 2 is a block diagram to explain placement of a control apparatus;

FIG. 3 is a block diagram to explain a configuration of the control apparatus;

FIG. 4 is a diagram to explain information elements of information configured by maintenance personnel;

FIG. 5 is a diagram to explain information elements of flow information;

FIG. 6 is a diagram to explain information elements of user information;

FIG. 7 is a diagram to explain information elements of log information for control and statistics information for control;

FIG. 8 is a diagram to explain information elements of transmission control information;

FIG. 9A is a sequence diagram to explain a process for acquiring user information;

FIG. 9B is a sequence diagram to explain a process for acquiring user information;

FIG. 10 is a sequence diagram to explain a process for acquiring user information;

FIG. 11 is a sequence diagram to explain a process for acquiring log information for control and statistics information for control;

FIG. 12 is a sequence diagram to explain a process for identifying a user engaged in transmitting/receiving user data and associating an application being executed by the user with the user;

FIG. 13 is a flowchart illustrating a process for clearing a counter for statistics information for control;

FIG. 14 is a flowchart illustrating a traffic control action;

FIG. 15 is a flowchart illustrating a traffic control action;

FIG. 16 is a flowchart illustrating a traffic control action;

FIG. 17 is a flowchart illustrating a traffic control action;

FIG. 18 is a flowchart illustrating a procedure for a traffic control action;

FIG. 19 is a flowchart illustrating a procedure for a traffic control action;

FIG. 20 presents information elements of statistics information for control which are used to acquire an anticipated transaction amount per unit time as statistics information;

FIG. 21 is a diagram to explain information for predicting a signaling burst occurrence; and

FIG. 22 is a diagram to explain signaling in which an information element that identifies an application or mobile terminal type is added.

### DETAILED DESCRIPTION OF PREFERRED EMBODIMENTS

### First Embodiment

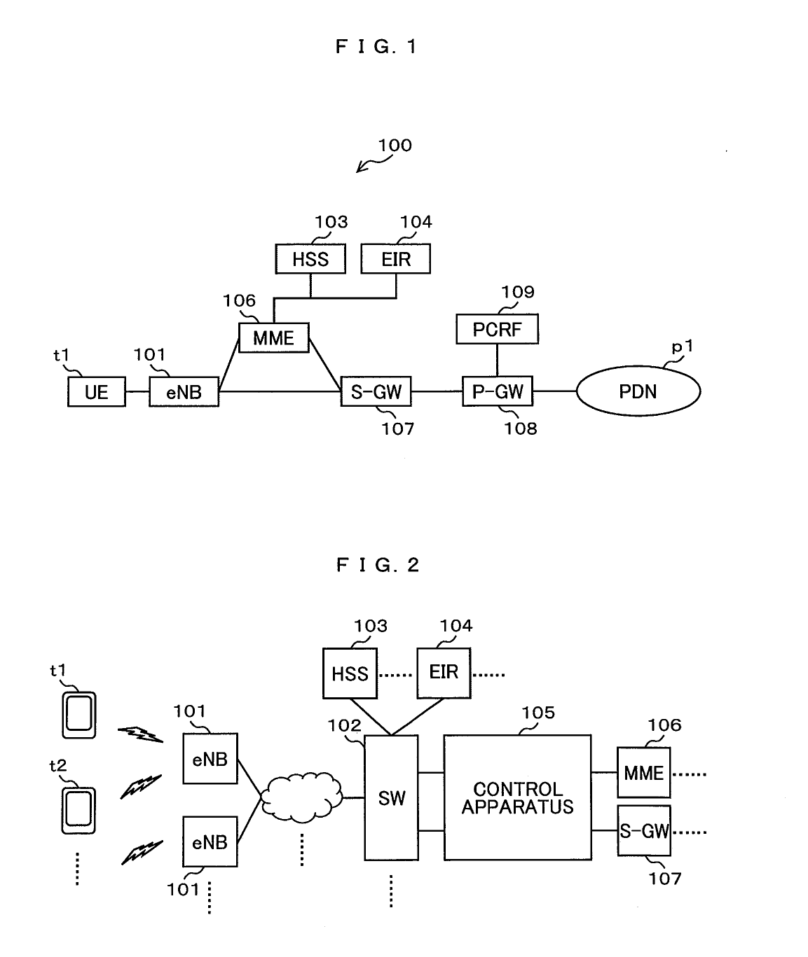

First, an embodiment is described with FIGS. 1 thru 13. The embodiment is described here, citing an example of a Long Term Evolution (LTE) system. In the embodiment, particularly, according to Control Plane (C-Plane), General packet radio service Tunneling Protocol (GTP) tunnels for transferring packets of user data are established for each mobile terminal in a packet communication network. Packets of user data are transmitted and received via a radio network and through the use of the GTP tunnels. Note that the scope of application is not limited to LTE.

### <Network Architecture Example>

With reference to FIG. 1, a network architecture is described. In a network 100, User Equipment (UE) t1 which is a mobile terminal is connected to a base station eNB 101 via a radio bearer link. Concrete examples of mobile terminals t1 include, but not limited to, a mobile phone, smart phone, a tablet mobile terminal, a gaming console, a notebook personal computer, and a car navigator.

The eNB 101 is also connected to a Serving Gateway (S-GW) 107 and relays communication between the mobile terminal t1 and the S-GW 107.

The S-GW 107 is a node that relays user data from the mobile terminal t1 and relays data from a server in a Packet Data Network (PDN) p1.

A Mobility Management Entity (MME) 106 is connected to the eNB 101, the S-GW 107, a Home Subscriber Server (HSS) 103, and an Equipment Identity Register (EIR) 104. The MME 106 is a node that performs mobility management of a mobile terminal, such as registering the location of the mobile terminal t1, calling out the terminal, and management of a handover of the mobile terminal t1 when the terminal moves from a cell of one eNB 101 to a cell of another eNB 101.

A Packet Data Network Gateway (P-GW) 108 is connected to the S-GW 107 and a Policy and Charging Rule Function (PCRF) 109. The P-GW 108 is a node that relays packets between the S-GW 107 and the PDN p1. The PDN p1 is a communication network including a server that communicates with a mobile terminal t1. Concrete examples of the server include, but not limited to, a web server, a file server, a database server, and an application server. Note that the number of terminals and nodes which are components depicted in FIG. 1 is not limited to the number as depicted.

### <Placement of Control Apparatus>

With reference to FIG. 2, the placement of the control apparatus is described.

A case is described where the control apparatus 105 in the present embodiment is placed between an eNB 101 and the MME 106 and between an eNB 101 and the S-GW 107. The control apparatus 105, depicted in FIG. 2, is placed in a location apt for control of mobile communication signaling toward the MME 106. However, the location of the control apparatus 105 is not limited to that depicted in FIG. 2. The control apparatus 105 may be placed in any other location, provided that packets between an eNB 101 and the MME 106 pass through that location and the control apparatus in that location can monitor packets between an eNB 101 and the S-GW 107. If control is exerted on mobile communication signaling to any other mobile communication device, the control apparatus may be placed in a location through which packets that are transmitted to and received from that device pass. Note that the number of terminals and nodes which are components depicted in FIG. 2, including the control apparatus 105, is not limited to the number as depicted.

### <Configuration Example of the Control Apparatus>

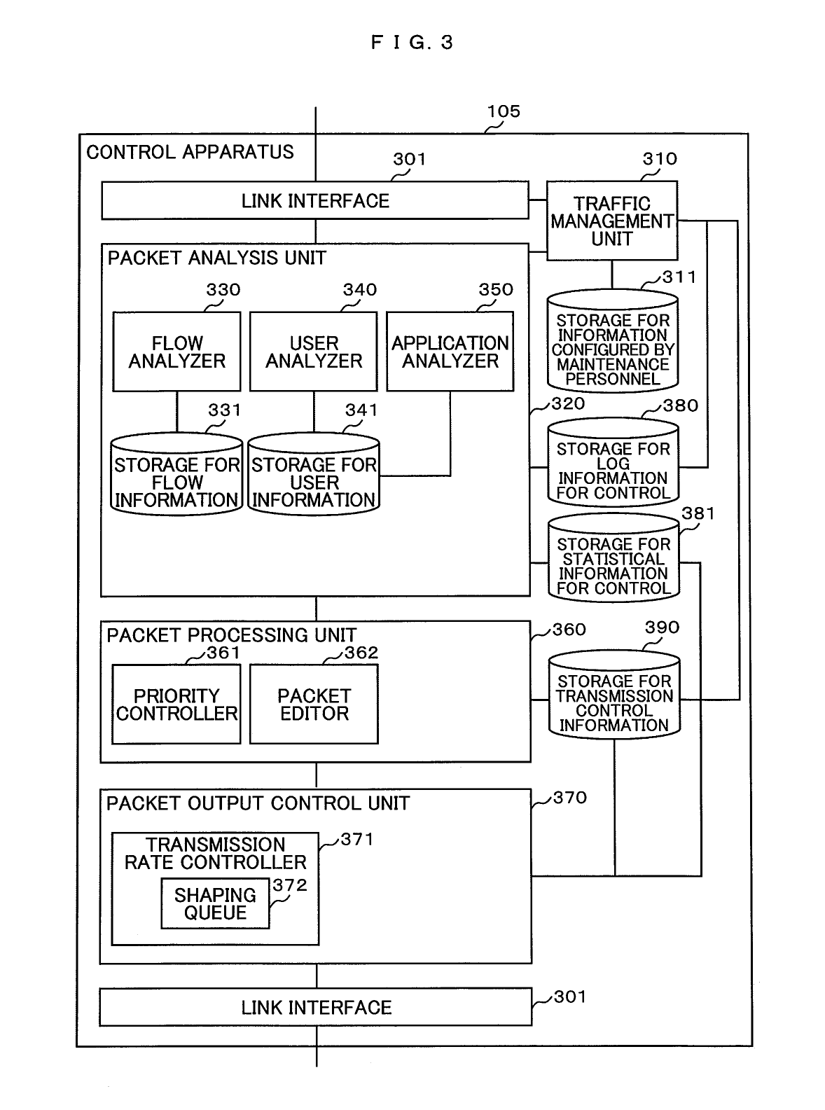

With reference to FIG. 3, a configuration of the control apparatus is described.

The control apparatus 105 includes link interfaces 301, a processor (not depicted), a memory (not depicted), a traffic management unit 310, a storage for information 311 configured by maintenance personnel, a packet analysis unit 320, a packet processing unit 360, a packet output control unit 370, and storages for log information 380 for control, statistics information 381 for control, and transmission control information 390. The packet analysis unit 320 includes a flow analyzer 330, a storage for flow information 331, a user analyzer 340, a storage for user information 341, and an application analyzer 350. The packet processing unit 360 includes a priority controller 361 and a packet editor 362. The packet output control unit 370 includes a transmission rate controller 371. The transmission rate controller 371 includes a shaping queue 372 which is used when control of shaping is performed.

Note that the number of link interfaces depicted in FIG. 3 is exemplary and there is no limitation to that number. For example, separate interfaces for information configured by maintenance personnel, signaling of mobile communication, and user data of mobile communication may be provided.

The functional configuration of the control apparatus depicted in FIG. 3 is exemplary. Logical function blocks may be combined or divided, provided that procedures which will be described with regard to an embodiment can be implemented. Further, one control apparatus may be physically divided into a plurality of apparatuses. For example, the control apparatus may be divided into a server, a user and application analysis apparatus, and an apparatus for implementing traffic control. The server may include a link interface 301 and the traffic management unit 310; it may manage information 311 configured by maintenance personnel and set flow information 331 and transmission control information 390 into the apparatus for implementing traffic control. The user and application analysis apparatus may include a link interface 301 as well as the user analyzer 340 and the application analyzer 350 in the packet analysis unit 320. This apparatus may manage user information 341, log information 380 for control, and statistics information 381 for control and send information from the log information 380 for control and the statistics information 381 for control to the server, so that the server will judge which packet/flow should be under traffic control. The apparatus for implementing traffic control may include a link interface 301, the flow analyzer 330 in the packet analysis unit 320, the priority controller 361 and the packet editor 362 in the packet processing unit 360, and the transmission rate controller 371 and the shaping queue 372 in the packet output control unit 370. This apparatus may manage flow information 331 and transmission control information 390, generate a copy of a received packet for traffic analysis, and transfer it to the user and application analysis apparatus. Also, this apparatus may perform a traffic control action on a received packet and forward the packet to an external device such as eNB 101, HSS 103, EIR 104, MME 106, or S-GW 107.

The link interfaces 301 are communication interfaces for receiving and transmitting packets. One link interface 301 is adapted to receive a packet from an external device, i.e., any of the following: eNB 101, HSS 103, EIR 104, MME 106, and S-GW 107. The received packet is input to the packet analysis unit 320 and passed to the packet processing unit 360 and to the packet output control unit 370, and is eventually forwarded by the other link interface 301 to an external device, i.e., any of the following: eNB 101, HSS 103, EIR 104, MME 106, and S-GW 107. The one link interface 301 also transfers information configured by a maintenance personnel interface to the traffic management unit 310.

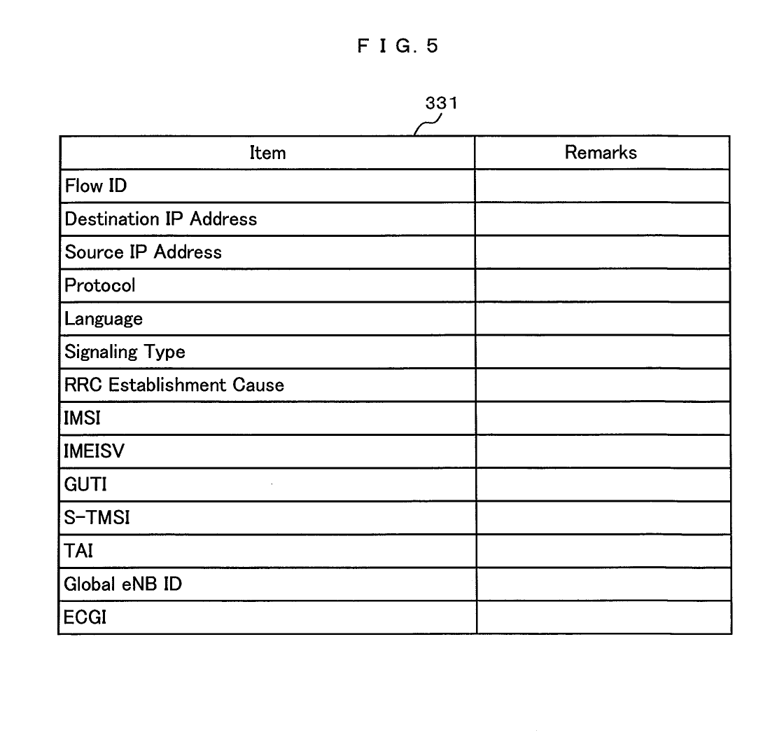

The traffic management unit 310 stores information that has been configured by a maintenance personnel, received via the link interface 301, into the storage for information 311 configured by maintenance personnel. Also, the traffic management unit 310 sets the information 311 configured by maintenance personnel into the storage for transmission control information 390. Also, the traffic management unit 310 converts the information 311 configured by maintenance personnel to flow information and sends the flow information to the packet analysis unit 320. Processing for converting information configured by maintenance personnel to flow information will be described with FIG. 5.

The packet analysis unit 320 includes the flow analyzer 330, the storage for flow information 331, the user analyzer 340, the storage for user information 341, and the application analyzer 350. The packet analysis unit 320 analyzes a packet received from an external device, i.e., any of the following: eNB 101, HSS 103, EIR 104, MME 106, and S-GW 107.

The flow analyzer 330 refers to flow information 331, determines whether a received packet meets a flow specified in the flow information, and, if so, attaches to the packet a flow ID which is the identifier of a flow associated with the packet. Here, if the packet includes a plurality of pieces of signaling data, the flow analyzer 330 determines whether each piece of signaling data belongs to a flow that should be under traffic control and assigns a separate flow ID for each piece of signaling data so determined. As a result of reference to the flow information 331, if there is no flow that the received packet meets (that is, the packet does not include signaling or the like that should be under traffic control), the flow analyzer 330 transfers the received packet as is to the packet processing unit 360.

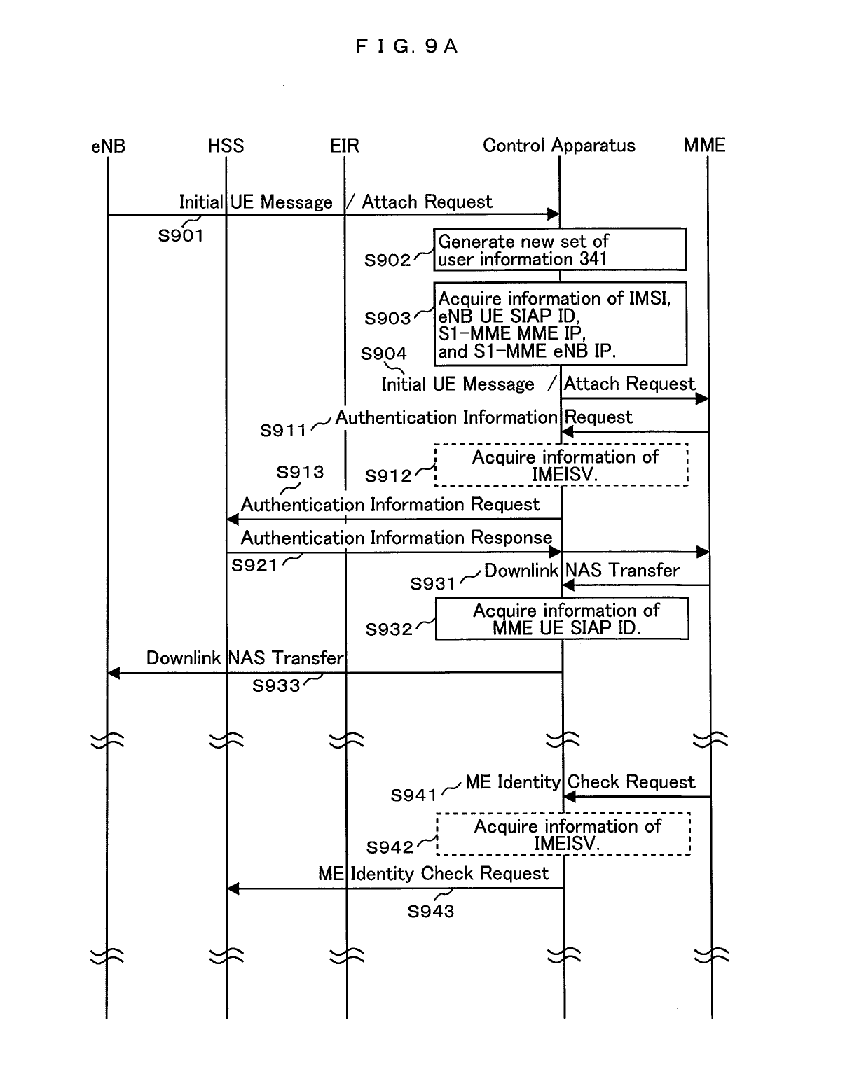

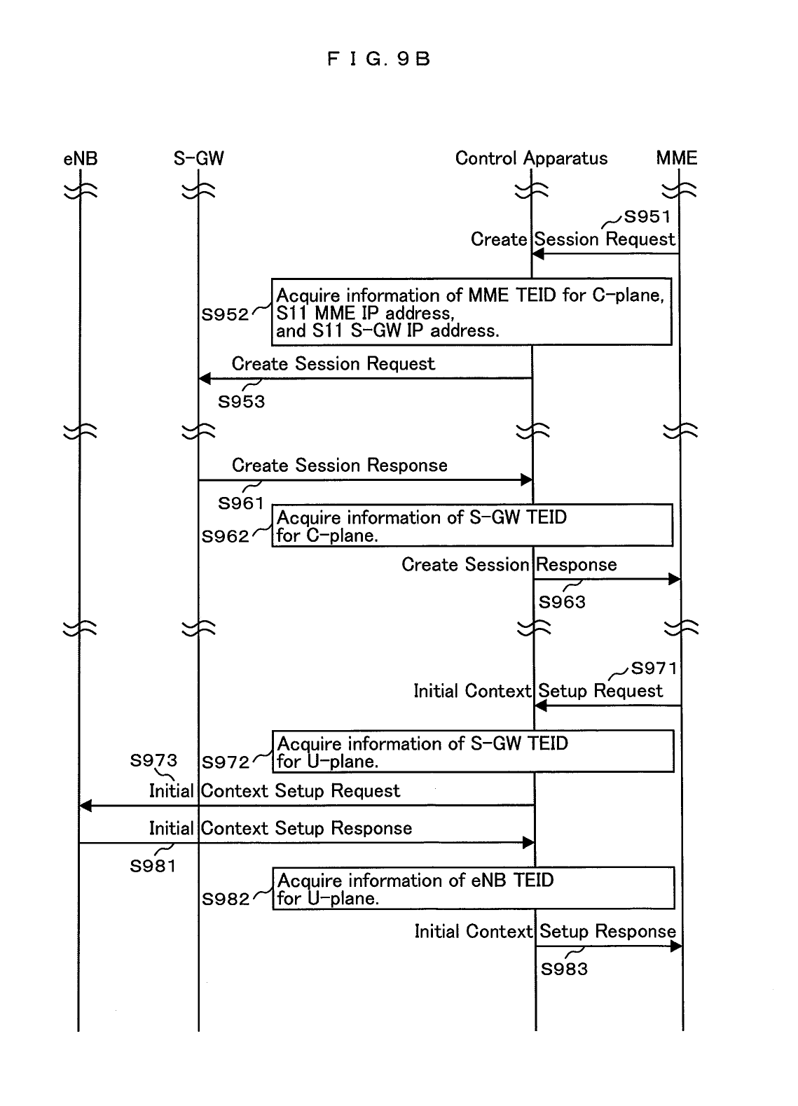

The user analyzer 340 analyzes a received packet and acquires the following information on a mobile terminal t1: its identifier, equipment type, and session-related information. It manages these items of information as user information 341. In mobile communication, for each of devices (nodes) participated in transmitting and receiving signaling and data to/from one mobile terminal, their uplink and downlink IDs are assigned and managed. In the present embodiment, triggered by signaling for initial connection of a mobile terminal to the network, the control apparatus continues to monitor signaling between devices (nodes) to take place subsequently, as will be described in detail with FIG. 9. All uplink and downlink IDs for each of devices (nodes) participated in transmitting and receiving signaling and data, as mentioned above, acquired by the monitoring are associatively stored into the storage for user information 341 on a per-user basis. The storage for user information 341 is, so to say, a list of IDs; this storage is for storing, for each mobile terminal, various kinds of IDs that the mobile terminal uses in mobile communication.

If a received packet is a packet for signaling of mobile communication, the user analyzer 340 stores a time instant at which the control apparatus receives the packet, the type of signaling of mobile communication received, and information on the identifier and equipment type of a mobile terminal t1 relevant to the signaling of mobile communication received into the storage for log information 380 for control.

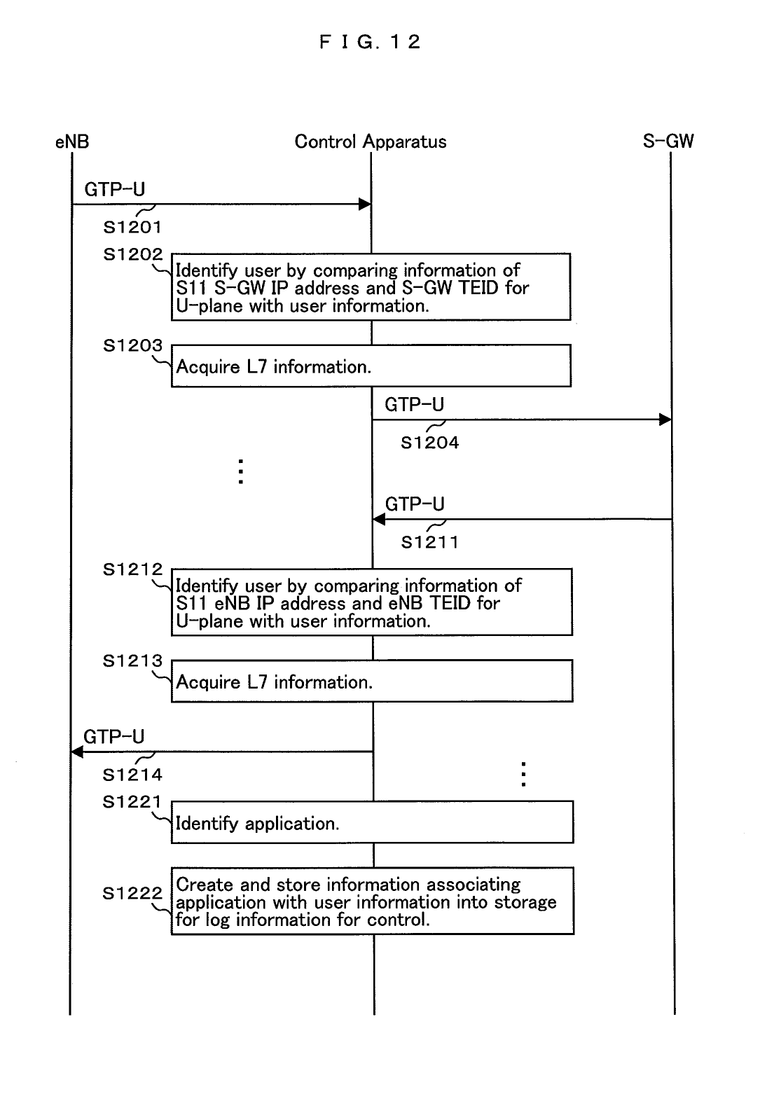

The application analyzer 350 analyzes a received packet of user data of mobile communication and identifies an application according to a process which will be described with FIG. 12. Also, the application analyzer 350 refers to user information 341, identifies which mobile terminal t1 is an endpoint engaged in transmitting/receiving the packet from ID data included in the received packet, and acquires the identifier information of the terminal. Here, even if ID data for communication between eNB and S-GW is only included in the packet of user data, because the storage for user information 341 stores a suite of IDs pertinent to a mobile terminal t1, the application analyzer 350 can identify the mobile terminal by associating the ID data in the user packet with a terminal unique ID such as, e.g., IMSI (International Mobile Subscriber Identity). Also, the application analyzer 350 can identify the equipment type of a mobile terminal t1 from IMEISV which is stored in the storage for user information 341.

The application analyzer 350 stores into the storage for log information 380 for control the following information: a time instant at which the control apparatus first received a packet carrying data of an application after the termination of a process of signaling of mobile communication as the time instant at which the application is started after the termination of a process of signaling of mobile communication; the identifier of a mobile terminal T1 included in received user data of mobile communication; the equipment type of the mobile terminal T1 included in received user data of mobile communication; and information on an application included in received user data of mobile communication.

The packet processing unit 360 includes the priority controller 361 and the packet editor 362. The packet processing unit 360 edits or discards a received packet, based on a flow ID attached to the packet and according to a way of packet processing for each flow stored in the storage for transmission control information 390. If flow ID information is not attached to the packet, the packet processing unit 360 transfers the received packet as is to the packet output control unit 370.

For a packet received from the packet analysis unit, the priority controller 361 refers to transmission control information 390, identifies priority information for the packet associated with the flow ID of the packet, and attaches the priority information to the received packet. Here, if the packet includes a plurality of pieces of signaling data, flow IDs are assigned to the pieces of signaling data respectively. Because a way of flow control for each flow ID is stored in the storage for transmission control information 390, control on a per-signaling basis can be implemented if one packet includes a plurality of pieces of signaling data.

For a packet received from the packet analysis unit, the packet editor 362 refers to transmission control information 390 and determines a way of processing the packet associated with the flow ID of the packet. If the way of processing is to discard the packet, the packet editor 362 discards the packet received from the packet analysis unit 320 and does not transfer it to the packet output control unit. If the way of processing is to edit the packet, the packet editor 362 edits the packet according to a specified way of editing and forward the packet to the packet output control unit 370.

For a packet received from the packet processing unit 360, the packet output control unit 370 refers to transmission control information 390 and determines a way of transmission of the packet associated with the flow ID of the packet. If the way of transmission is shaping, the packet output control unit 370 stores the received packet into the shaping queue 372, performs traffic shaping according to an output rate acquired from the transmission control information 390, and forwards the packet to an external device, i.e., any of the following: eNB 101, HSS 103, EIR 104, MME 106, and S-GW 107.

If the way of transmission is policing, the packet output control unit 370 performs traffic policing according to an output rate acquired from the transmission control information 390, and forwards the packet to an external device, i.e., any of the following: eNB 101, HSS 103, EIR 104, MME 106, and S-GW 107. If discarding a packet is required by the traffic policing, the packet output control unit 370 discards a packet of a high discard priority first, according to discard priority attached to each packet. If flow ID information is not attached to the packet, the packet output control unit 370 forwards the received packet as is to an external device.

### <Information Configured by Maintenance Personnel>

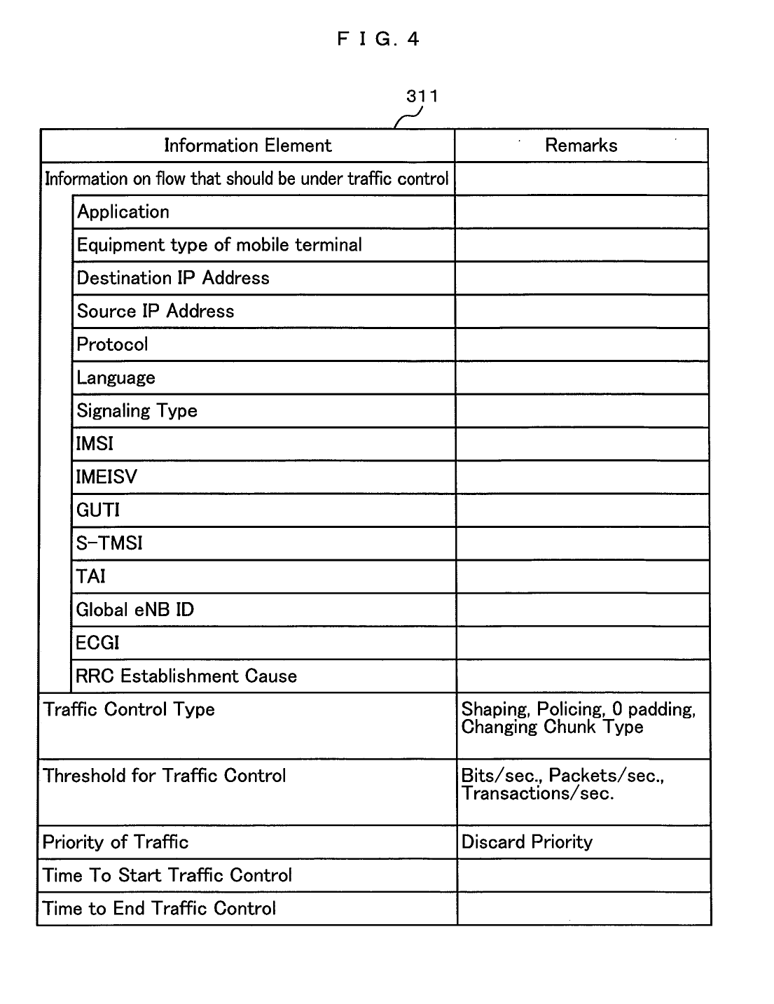

With reference to FIG. 4, information elements of information configured by maintenance personnel are described.

The storage for information 311 configured by maintenance personnel stores maintenance information entered by a maintenance personnel using a maintenance terminal (not depicted) or the like. As information elements of information 311 configured by maintenance personnel, to carry out one type of traffic control, the maintenance personnel configures one set of information elements as follows: information on a flow that should be under traffic control, traffic control type, a threshold for traffic control, priority of traffic, time to start traffic control, and time to end traffic control. If a plurality of types of traffic control are carried out, a plurality of sets of the above information elements are configured for the information 311 configured by maintenance personnel. It is omissible to configure the priority of traffic, time to start traffic control, and time to end traffic control.

Information on a flow that should be under traffic control provides prescribed conditions for sorting out a packet or signaling for which the apparatus should perform a traffic control action. Information elements of the information on a flow that should be under traffic control are listed below. An information element may be configured, which is selected from the following: application, equipment type of a mobile terminal, destination IP address, source IP address, protocol, language, signaling type, IMSI, Globally Unique Temporary Identity (GUTI), SAE-Temporary Mobile Subscriber Identity (S-TMSI), Tracking Area Identity (TAI), Global eNB ID, E-UTRAN Cell Global Identifier (ECGI), and Radio Resource Control (RRC) Establishment Cause. Among these information elements of the information on a flow that should be under traffic control, a combination of plural information elements can also be configured, not limited to one information element. Specifically, “application” and “destination IP address” may be specified in combination. Thereby, a condition of meeting both information elements can be set.

Note that the information elements of the information on a flow that should be under traffic control listed in FIG. 4 are exemplary. Any information element that is included in a communication packet (specifically, an information element such as “Type of Service”) or any information element for grouping devices and persons pertinent to packet transmission (specifically, gender information such as man/woman for grouping end users pertinent to packet transmission) can be acquired by reference to a server on which subscriber information or the like is stored with a search key specified from user information 341, and defined as an information element of the information on a flow that should be under traffic control.

Of the information on a flow that should be under traffic control, “application” is an information element for specifying an application as a condition for sorting out a packet for which the apparatus should perform a traffic control action.

Of the information on a flow that should be under traffic control, “equipment type of a mobile terminal” is an information element for specifying the equipment type of a mobile terminal, specifically, such as “Smart Phone” provided by company A, a mobile communication operator, as a condition for sorting out a packet for which the apparatus should perform a traffic control action.

Of the information on a flow that should be under traffic control, “destination IP address” is an information element for specifying a destination IP address that is included in an IP header of a packet received by the control apparatus 105, as a condition for sorting out a packet for which the apparatus should perform a traffic control action.

Of the information on a flow that should be under traffic control, “source IP address” is an information element for specifying a source IP address that is included in the IP header of a received packet, as a condition for sorting out a packet for which the apparatus should perform a traffic control action.

Of the information on a flow that should be under traffic control, “protocol” is an information element for specifying a protocol such as SCTP, S1-AP, or HTTP that is included in a received packet, as a condition for sorting out a packet for which the apparatus should perform a traffic control action.

Of the information on a flow that should be under traffic control, “language” is an information element for specifying a language such as HTML5 that is included in a received packet, as a condition for sorting out a packet for which the apparatus should perform a traffic control action.

Of the information on a flow that should be under traffic control, “signaling type” is an information element for specifying a signaling type such as a “Service Request” message which is prescribed in a 3^{rd} Generation Partnership Project (3GPP) standard, as a condition for sorting out a packet for which the apparatus should perform a traffic control action.

Of the information on a flow that should be under traffic control, “IMSI” is an information element for specifying an IMSI, i.e., a mobile terminal user identifier which is prescribed in an ITU standard, as a condition for sorting out a packet for which the apparatus should perform a traffic control action.

Of the information on a flow that should be under traffic control, “GUTI” is an information element for specifying a Global Unique Temporary Identity which is prescribed in a 3GPP standard, as a condition for sorting out a packet for which the apparatus should perform a traffic control action.

Of the information on a flow that should be under traffic control, “S-TMSI” is an information element for specifying an SAE Temporary Mobile Subscriber Identity which is prescribed in a 3GPP standard, as a condition for sorting out a packet for which the apparatus should perform a traffic control action.

Of the information on a flow that should be under traffic control, “TAI” is an information element for specifying a Tracking Area Identity which is prescribed in a 3GPP standard, as a condition for sorting out a packet for which the apparatus should perform a traffic control action.

Of the information on a flow that should be under traffic control, “Global eNB ID” is an information element for specifying a Global eNB ID which is prescribed in a 3GPP standard, as a condition for sorting out a packet for which the apparatus should perform a traffic control action.

Of the information on a flow that should be under traffic control, “ECGI” is an information element for specifying an E-UTRAN Cell Global ID which is prescribed in a 3GPP standard, as a condition for sorting out a packet for which the apparatus should perform a traffic control action.

Of the information on a flow that should be under traffic control, “RRC Establishment Cause” is an information element for specifying an RRC Establishment Cause which is prescribed in a 3GPP standard, as a condition for sorting out a packet for which the apparatus should perform a traffic control action. “RRC Establishment Cause” is an information element that indicates a cause for connection of a mobile terminal in standby state to a mobile system, such as “emergency” meaning an emergency connection, “HighPriorityAcess” meaning a high priority connection, “mt-access” meaning a call arrival, “mo-Signaling” meaning call origination for signaling, or “mo-Data” meaning call origination for data communication. For this information element, a plurality of parameters can be selected.

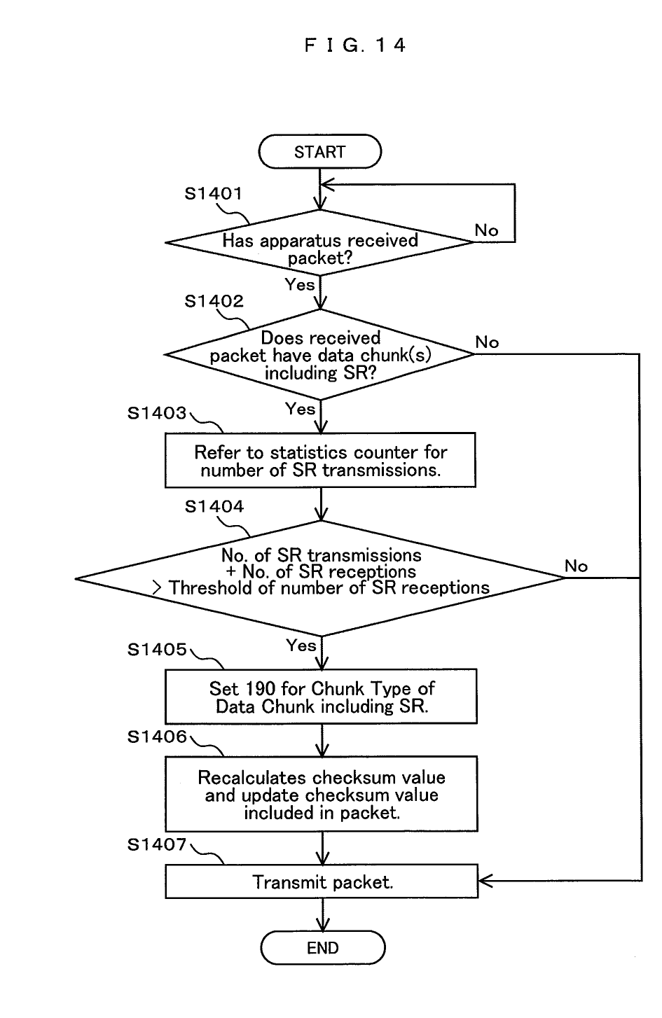

“Traffic control type” is an information element for setting what type of a traffic control action should be performed for a flow sorted as the one to be controlled by using the information on a flow that should be under traffic control. Specifically, a selection can be made from candidates such as “0 padding”, “changing chunk type”, “chunk deletion”, “shaping”, and “policing”. How the control apparatus 105 behaves when each of the candidates has been selected will be described with FIG. 14 and subsequent figures.

“Threshold for traffic control” is an information element for setting a threshold value by which a traffic control action set for “traffic control type” should be performed. As a threshold value, rates including bits/sec., packets/sec., and transactions/sec. may be specified. Note that a single threshold value is not always set. A threshold value setting may be changed depending on the following category: date, a day of the week, hour, and holiday. Time-dependent value setting is possible; specifically, for an hour after 6 p.m., when traffic is anticipated to increase, a lower threshold value is set than for other hours. If no threshold for traffic control is set, the traffic control apparatus should perform a traffic control action set for “traffic control type” for all packets meeting conditions specified by the information on a flow that should be under traffic control.

“Priority of traffic” is an information element for setting the priority of an action to be performed according to the information on a flow that should be under traffic control. As the priority, specifically, a discard priority or the like should be specified. If no threshold for traffic control is set, the traffic control apparatus should set the same priority for any flows sorted as those to be controlled according to the information on a flow that should be under traffic control. The Lowest discard priority should be set for packets that do not meet conditions specified by the information on a flow that should be under traffic control.

“Time to start traffic control” is an information element for setting a time instant to start traffic control. If the information element, “time to start traffic control”, is set, before the time to start, the apparatus should not perform traffic control for all packets meeting conditions specified by the information on a flow that should be under traffic control and should forward the packets as is. At and after the time to start, the control apparatus should make a decision by a threshold value set for “threshold for traffic control” and perform a traffic control action set for “traffic control type”.

“Time to end traffic control” is an information element for setting a time instant to end traffic control. If the information element, “time to end traffic control”, is set, until the time to end, the control apparatus should make a decision by a threshold value set for “threshold for traffic control” and perform a traffic control action set for “traffic control type”. After the time to end, the traffic control apparatus should not perform traffic control for any packets meeting conditions specified by the information on a flow that should be under traffic control and should forward the packets as is.

Unless the information elements, “time to start traffic control” and “time to end traffic control” are set, the traffic control apparatus should always make a decision by a threshold value set for “threshold for traffic control” and perform a traffic control action set for “traffic control type” for all packets meeting conditions specified by the information on a flow that should be under traffic control.

### <Flow Information>

With reference to FIG. 5, information elements of flow information are described.

Flow information 311 is used in analyzing a packet including one or more pieces of signaling data received by the control apparatus 105 and this information provides prescribed conditions for discriminating whether or not each signaling belongs to a flow that should be under traffic control. The flow analyzer 330 compares information elements included in the received packet with the information elements of flow information. If there is a match between the information elements of both, the flow analyzer 330 determines that the packet should be under traffic control, acquires the corresponding flow ID from the flow information, and attaches the flow ID to the packet. If there is a mismatch between the information elements of the flow information and the information elements included in the packet, the flow analyzer 330 sorts the packet as the one for which the apparatus should not perform a traffic control action.

Flow information 311 is generated by the traffic management unit 310, based on the information 311 configured by maintenance personnel, user information 341, and statistics information 381 for control. A method for generating flow information from the information 311 configured by maintenance personnel, user information, and statistics information 381 for control is set forth below.

The flow information 311 specifically includes a flow ID and an information element which is selected from the following: destination IP address, source IP address, protocol, language, signaling type, RRC Establishment Cause, IMSI, International Mobile Equipment Identity Software Version (IMEISV), GUTI, S-TMSI, TAI, Global eNB ID, and ECGI. Among these information elements of flow information to be specified for one flow ID, a combination of plural information elements can also be configured, not limited to one information element. Specifically, “signaling type” and “RRC Establishment Cause” may be specified in combination. Thereby, a condition of meeting both information elements can be set. As for information elements of flow information, an information element, e.g., “Type of Service” that is included in a communication packet, other than those listed above, can also be defined as an information element of flow information.

Of the flow information 311, “flow ID” is the identifier of a flow. When generating information on a flow, the traffic management unit assigns a unique value of flow ID to the flow for each combination of conditions for sorting out packets within the control apparatus.

Of the flow information 311, “destination IP address” is set identical to the value of “destination IP address” of the information on a flow that should be under traffic control. If there is no setting of “destination IP address” in the information on a flow that should be under traffic control, the traffic management unit does not set “destination IP address” in the flow information 311.

Of the flow information 311, “source IP address” is set identical to the value of “source IP address” of the information on a flow that should be under traffic control. If there is no setting of “source IP address” in the information on a flow that should be under traffic control, the traffic management unit does not set “source IP address” in the flow information 311.

Of the flow information 311, “protocol” is set identical to the value of “protocol” of the information on a flow that should be under traffic control. If there is no setting of “protocol” in the information on a flow that should be under traffic control, the traffic management unit does not set “protocol” in the flow information 311.

Of the flow information 311, “language” is set identical to the value of “language” of the information on a flow that should be under traffic control. If there is no setting of language” in the information on a flow that should be under traffic control, the traffic management unit does not set “language” in the flow information 311.

Of the flow information 311, “signaling type” is set identical to the value of “signaling type” of the information on a flow that should be under traffic control. If there is no setting of “signaling type” in the information on a flow that should be under traffic control, the traffic management unit does not set “signaling type” in the flow information 311.

Of the flow information 311, “RRC Establishment Cause” is set identical to the value of “RRC Establishment Cause” of the information on a flow that should be under traffic control. If there is no setting of “RRC Establishment Cause” in the information on a flow that should be under traffic control, the traffic management unit does not set “RRC Establishment Cause” in the flow information 311.

Of the flow information 311, “IMSI” is set identical to the value of “IMSI” of the information on a flow that should be under traffic control. If there is no setting of “IMSI” in the information on a flow that should be under traffic control, the traffic management unit does not set an “IMSI” information element in the flow information 311.

Of the flow information 311, “IMEISV” is set as follows: if the equipment type of a mobile terminal is set in the information on a flow that should be under traffic control, “IMEISV” is set by converting the equipment type information to a value of mobile terminal equipment type described in upper 8 bits of IMEISV and acquiring a value of IMEISV including the value of mobile terminal equipment type contained in the converted IMEISV from “IMEISV” of user information 341. If two or more values of IMEISV are acquired, the traffic management unit generates flow information separately for each value of IMEISV. Conversion of the equipment type information of a mobile terminal to a mobile terminal equipment type contained in upper 8 bits of IMEISV should comply with a rule of assignment to a mobile terminal equipment type prescribed by each mobile terminal supplier. If “IMEISV” is set in the information on a flow that should be under traffic control, “IMEISV” of the flow information 311 is set identical to the value of the “IMEISV” of the information on a flow that should be under traffic control. If there are no settings of “equipment type of a mobile terminal” and “IMEISV” in the information on a flow that should be under traffic control, the traffic management unit does not set “IMEISV” in the flow information 311.

Of the flow information 311, “GUTI” is set identical to the value of “GUTI” of the information on a flow that should be under traffic control. If, in the information on a flow that should be under traffic control, “GUTI” is not set, whereas an “application” is set, the control apparatus 105 performs processing as follows: it refers to user information 340 and log information 380 for control, extracts a time period when the specified application is executed and a value of GUTI of a mobile terminal that executes the application for the time period, determines a GUTI for which it should perform a traffic control action for each time period, and updates GUTI information for each time period.

If, in the information on a flow that should be under traffic control, “GUTI” is not set, whereas “equipment type of a mobile terminal” is set, the control apparatus 105 performs processing as follows: it refers to user information 340 and log information 380 for control, extracts a time period when the specified mobile terminal equipment type performs data communication and a value of GUTI of a mobile terminal that performed data communication for the time period, determines a GUTI for which it should perform a traffic control action for each time period, and updates GUTI information for each time period. If there are no settings of “application”, “equipment type of a mobile terminal”, and “GUTI” in the information on a flow that should be under traffic control, the control apparatus 105 does not set “GUTI” in the flow information 311.

Of the flow information 311, “S-TMSI” is set identical to the value of “S-TMSI” of the information on a flow that should be under traffic control. If, in the information on a flow that should be under traffic control, “S-TMSI” is not set, whereas an “application” is set, the control apparatus 105 performs processing as follows: it refers to user information 340 and log information 380 for control, extracts a time period when the specified application is executed and a value of S-TMSI of a mobile terminal that executes the application for the time period, determines an S-TMSI for which it should perform a traffic control action for each time period, and updates S-TMSI information for each time period. If, in the information on a flow that should be under traffic control, “S-TMSI” is not set, whereas “equipment type of a mobile terminal” is set, the control apparatus 105 performs processing as follows: it refers to user information 340 and log information 380 for control, extracts a time period when the specified mobile terminal equipment type performs data communication and a value of S-TMSI of a mobile terminal that performs data communication for the time period, determines an S-TMSI for which it should perform a traffic control action for each time period, and updates S-TMSI information for each time period. If there are no settings of “application”, “equipment type of a mobile terminal”, and “S-TMSI” in the information on a flow that should be under traffic control, the control apparatus 105 does not set “S-TMSI” in the flow information 311.

Of the flow information 311, “TAI” is set identical to the value of “TAI” of the information on a flow that should be under traffic control. If there is no setting of “TAI” in the information on a flow that should be under traffic control, the control apparatus 105 does not set “TAI” in the flow information 311.

Of the flow information 311, “Global eNB ID” is set identical to the value of “Global eNB ID” of the information on a flow that should be under traffic control. If there is no setting of “Global eNB ID” in the information on a flow that should be under traffic control, the control apparatus 105 does not set “Global eNB ID” in the flow information 311.

Of the flow information 311, “ECGI” is set identical to the value of “ECGI” of the information on a flow that should be under traffic control. If there is no setting of “ECGI” in the information on a flow that should be under traffic control, the control apparatus 105 does not set “ECGI” in the flow information 311.

### <User Information>

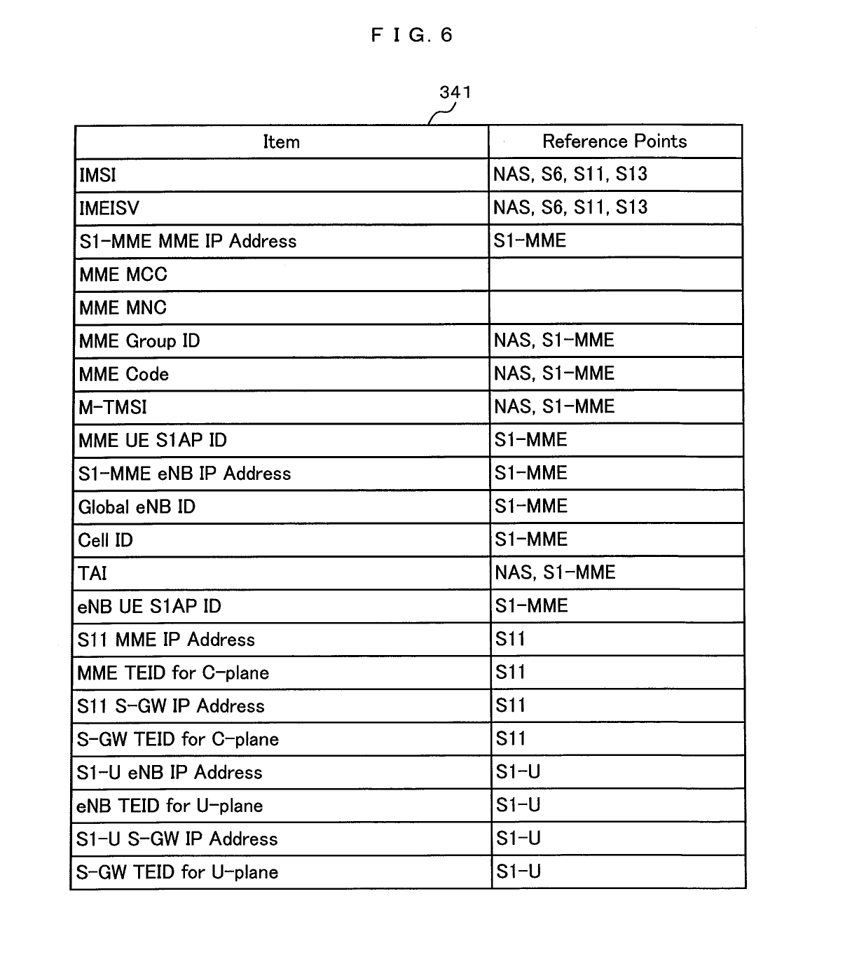

With reference to FIG. 6, information elements of user information 341 are described.

User information 341 is information pertinent to each mobile terminal which is used by the control apparatus 105 to control traffic.

As user information 341, information elements are managed, including: IMSI, IMEISV, S1-MME MME IP address, MME Group ID, MME Code, MME-Temporary Mobile Subscriber Identity (M-TMSI), MME UE S1 Application Protocol (S1AP) ID, S1-MME eNB IP address, Global eNB ID, Cell ID, TAI, eNB UE S1AP ID, S11 MME IP address, MME TEID for C-plane, S11 S-GW IP address, S-GW TEID for C-plane, S1-U eNB IP address, eNB TEID for U-plane, S1-U S-GW IP address, and S-GW TEID for U-plane. “TEID” is a Tunnel Endpoint identifier which is prescribed in a GTP protocol. As an information element of user information 341, any information element that is included in a communication packet such as “Type of Service” which is included in an Ether packet included in signaling can be managed in association with information such as IMSI which is a user identifier.

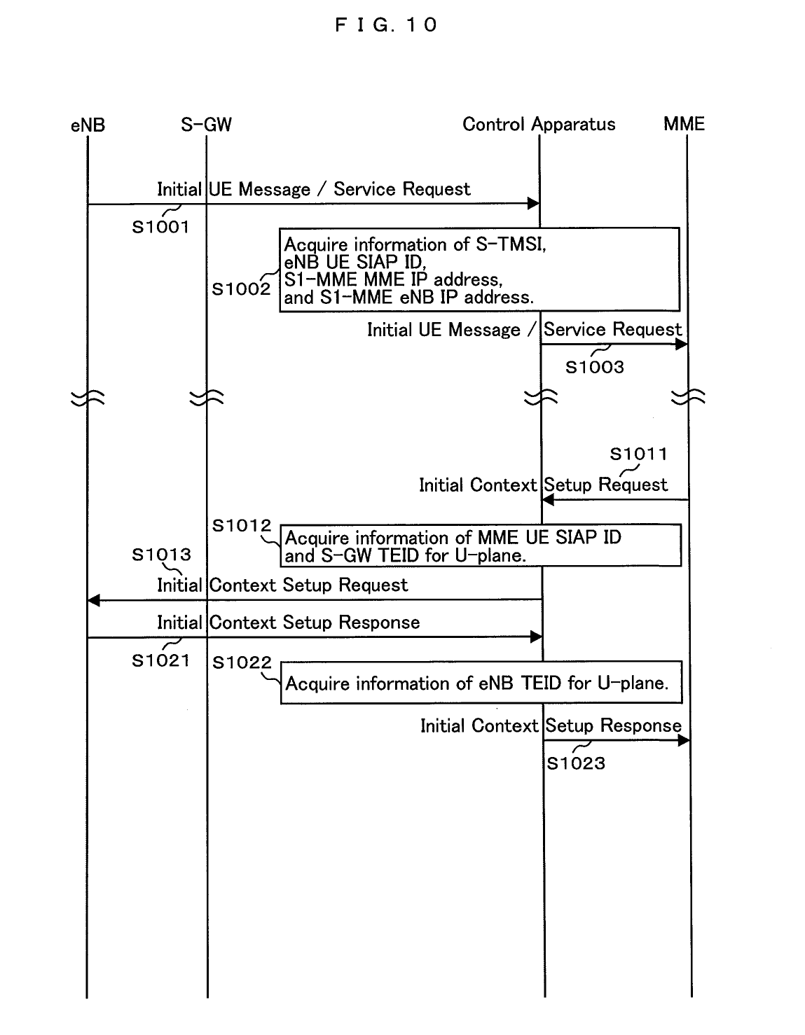

A method for acquiring each information element of user information 341 will be described with FIGS. 9A to 10.

Of the user information 341, “IMSI” is a mobile terminal user's identifier which is prescribed by International Telecommunication Union (ITU). Because a value of IMSI is unique across the world, other information elements of user information are associated with each IMSI and managed.

Of the user information 341, “IMEISV” is a mobile terminal identifier.

Of the user information 341, “S1-MME MME IP address” is an IP address of an MME 106 to which the mobile terminal user is connecting for a reference point of S1-MME. “S1-MME” is a reference point that denotes a connection path between an eNB 101 and an MME 106, which is prescribed in a 3GPP standard.

Of the user information 341, “MME MCC” is an MCC of the MME 106 to which the mobile terminal user is connecting. “Mobile Country Code (MMC)” is prescribed by ITU and a value of MMC in combination with a value of Mobile Network Code (MNC) is used as a mobile communication operator's identifier which is unique across the world. This information is acquired from “S1 Setup Response”, “MME Configuration Update”, or “Initial UE Message” of S1-AP protocol which is prescribed by 3GPP.

Of the user information 341, “MME MNC” is an MNC of the MME 106 to which the mobile terminal user is connecting. “Mobile Network Code (MNC)” is prescribed by ITU. “MNC” information is acquired from “S1 Setup Response”, “MME Configuration Update”, or “Initial UE Message” of S1-AP protocol which is prescribed by 3GPP.

Of the user information 341, “MME Group ID” is an MME Group ID of the MME 106 to which the mobile terminal user is connecting. “MME Group ID” is the identifier of a group to which an MME belong which is prescribed in a 3GPP standard. A value of MME Group ID is unique among MCC and MNC combinations. “MME Group ID” information is acquired from “S1 Setup Response”, “MME Configuration Update”, or “Initial UE Message” of S1-AP protocol which is prescribed by 3GPP.

Of the user information 341, “MME Code” is an MME code of the MME 106 to which the mobile terminal user is connecting. “MME Code” is an MME identifier within a MME group which is prescribed in a 3GPP standard and a value of MME code is unique within a group with an MME group ID.

Of the user information 341, “M-TMSI” is a mobile terminal user's identifier in the MME 106 to which the mobile terminal user is connecting. “M-TMSI” is prescribed in a 3GPP standard and a value of M-TMSI is unique within a node with an MME code.

Of the user information 341, “MME UE S1AP ID” is a mobile terminal user's identifier for the S1-MME path of the MME 106 to which the mobile terminal user is connecting. “MME UE S1AP ID” is prescribed in a 3GPP standard and a value of MME UE S1AP ID is unique within a node with an S1-MME MME IP address.

Of the user information 341, “S1-MME eNB IP address” is an IP address of an eNB 101 to which the mobile terminal user is connecting for a reference point of S1-MME.

Of the user information 341, “Global eNB ID” is an identifier of the eNB 101 to which the mobile terminal user is connecting. “Global eNB ID” is prescribed in a 3GPP standard and a value of Global eNB ID is unique around the world.

Of the user information 341, “Cell ID” is an identifier of a cell to which the mobile terminal user is connecting. “Cell ID” is prescribed in a 3GPP standard and a value of Cell ID is unique within a node with a Global eNB ID.

Of the user information 341, “TAI” is an identifier of a tracking area within which the mobile terminal user is located. “TAI” is prescribed in a 3GPP standard and a value of TAI is unique around the world.

Of the user information 341, “eNB UE S1AP ID” is a mobile terminal user's identifier for the S1-MME path of the eNB 101 to which the mobile terminal user is connecting. “MME UE S1AP ID” is prescribed in a 3GPP standard and a value of eNB UE S1AP ID is unique within a node with an S1-MME eNB IP address.

Of the user information 341, “S11 MME IP address” is an IP address of the MME 106 to which the mobile terminal user is connecting for a reference point of S1. S11 is a reference point that denotes a connection path between an MME 106 and an S-GW 107, which is prescribed in a 3GPP standard.

Of the user information 341, “MME TEID for C-plane” is a mobile terminal user identifier for the S11 path of the MME 106 to which the mobile terminal user is connecting. “TEID” is prescribed in a 3GPP standard and a value of MME TEID for C-plane is unique within a node with an S11 MME IP address.

Of the user information 341, an information element “S11 S-GW IP address” is an IP address of an S-GW 107 to which the mobile terminal user is connecting for the reference point of S11.

Of the user information 341, “S-GW TEID for C-plane” is a mobile terminal user's identifier for the S11 path of the MME 106 to which the mobile terminal user is connecting. “TEID” is prescribed in a 3GPP standard and a value of S-GW TEID for C-plane is unique within a node with an S11 S-GW IP address.

Of the user information 341, “S1-U eNB IP address” is an IP address of the eNB 101 to which the mobile terminal user is connecting for a reference point of S1-U. “S1-U” is a reference point that denotes a communication path between an eNB 101 and an S-GW 107, which is prescribed in a 3GPP standard.

Of the user information 341, “eNB TEID for U-plane” is an identifier of a bearer for the mobile terminal user for the S1-U path of the eNB 101 to which the mobile terminal user is connecting. “Bearer and TEID” are prescribed in a 3GPP standard and a value of eNB TEID for U-plane is unique within a node with an S1-U eNB IP address. Because each mobile terminal user can have a plurality of bearers as prescribed in a 3GPP standard, there may be plural values of eNB TEID for U-plane in the user information 341.

Of the user information 341, “S1-U S-GW IP address” is an IP address of the S-GW 107 to which the mobile terminal user is connecting for the reference point of S1-U.

Of the user information 341, “S-GW TEID for U-plane” is an identifier of a bearer for the mobile terminal user for the S1-U path of the S-GW 107 to which the mobile terminal user is connecting. “Bearer and TEID” are prescribed in a 3GPP standard and a value of S-GW TEID for U-plane is unique within a node with an S1-U S-GW IP address. Because each mobile terminal user can have a plurality of bearers as prescribed in a 3GPP standard, there may be plural values of S-GW TEID for U-plane in the user information 341.

### <Log Information for Control and Statistics Information for Control>

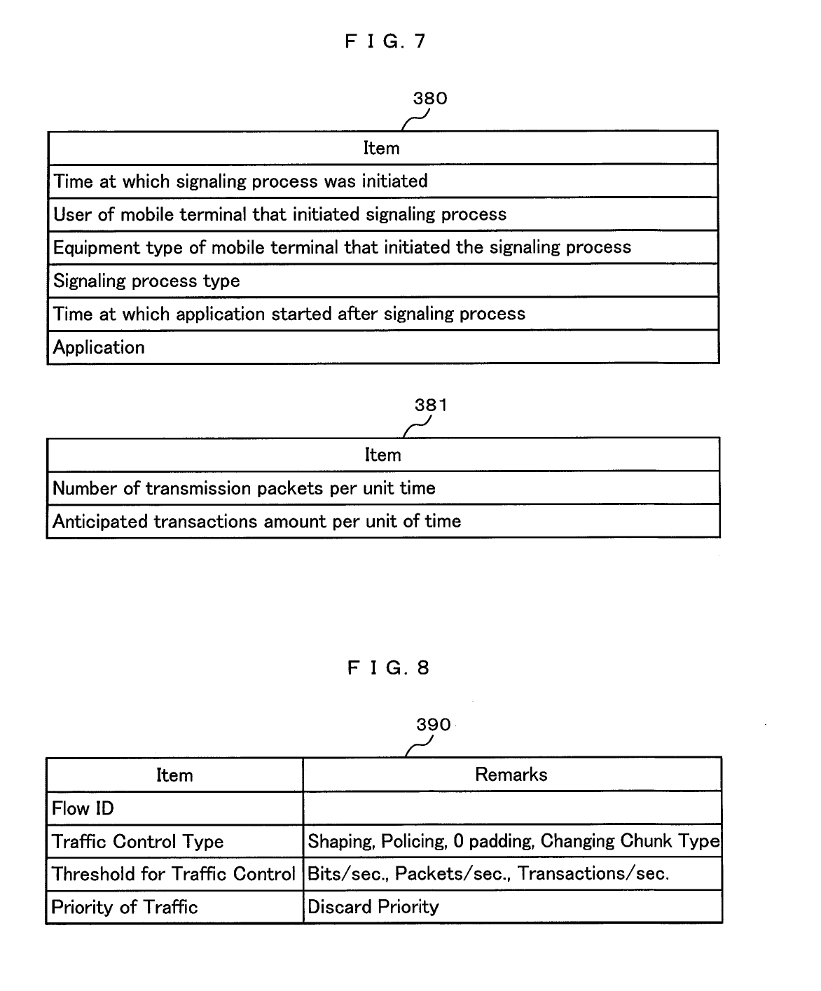

With reference to FIG. 7, information elements of log information for control and statistics information for control are described.

Log information for control 380 is statistical information that is used by the control apparatus 105 to determine which traffic control action should be performed at which time instant. Statistics information 381 for control is statistical information that is used to determine whether a traffic control action should be performed for a packet received by the control apparatus 105.

Log information for control 380 includes log information as follows: time at which a signaling process is initiated; the user of a mobile terminal that initiates the signaling process; the equipment type of the mobile terminal that initiates the signaling process; signaling process type; time at which an application starts after the signaling process; and application.

Time at which a signaling process is initiated is a time instant at which the mobile terminal user initiated a signaling process. The signaling process may be “Attach”, “Service Request”, etc. which are prescribed by 3GPP. The control apparatus 105 registers a time instant at which it receives a first transmission of signaling that should be received or transmitted by an MME 106 in each signaling process into the storage for log information 380 for control. The first transmission of signaling that should be received or transmitted by an MME 106 in each signaling process is prescribed by 3GPP. Specifically, in the case of an “Attach” process, the first transmission of signaling that should be received by an MME 106 is an “Attach Request” of NAS protocol. In the case of a “Service Request” process, the first transmission of signaling that should be received by an MME 106 is a “Service Request” of NAS protocol.

The user of a mobile terminal that initiated the signaling process is information identifying the user of the mobile terminal that initiated the signaling process. As the information identifying the mobile terminal user, specifically, the following may be registered into the storage for log information 380 for control: IMSI; GUTI; S1-MME MME IP address and S-TMSI; S1-MME MME IP address and MME UE S1AP ID; S1-MME eNB IP address and eNB UE S1AP ID; Global eNB ID and eNB UE S1AP ID; S11 MME IP address and MME TEID for C-plane; S11 S-GW IP address and S-GW TEID for C-plane; S1-U eNB IP address and eNB TEID for U-plane; S1-U S-GW IP address and S-GW TEID for U-plane; etc.

The equipment type of the mobile terminal that initiates the signaling process is information indicating the equipment type of the mobile terminal used by the mobile terminal user that initiates the signaling process. The control apparatus 105 registers the information indicating the equipment type of the mobile terminal, namely, IMEISV information or a part of IMEISV information into the storage for log information 380 for control.

Signaling process type is a type of the signaling process initiated by the mobile terminal user. The control apparatus 105 registers, as signaling process type, specifically, “Attach” or “Service Request”, among others, into the storage for log information 380 for control. Time at which an application starts after the signaling process is information indicating a time instant at which the mobile terminal user starts an application after the signaling process. The control apparatus 105 registers a time instant at which it receives a first transmission of user data after receiving the first transmission of signaling into the storage for log information 380 for control. Taking account of a possibility that a plurality of applications are executed after the signaling process, for each of the applications executed, information on the time at which an application started after the signaling process may be registered.

Application is information indicating the application executed by the mobile terminal user after the signaling process. Once having acquired information identifying the application, the control apparatus 105 registers such information into the storage for log information 380 for control. Taking account of a possibility that a plurality of applications are executed after the signaling process, for each of the applications executed, information on an application may be registered in combination with information on the time at which an application starts after the signaling process.

Statistics information 381 for control specifically includes the following statistical information: the number of transmission packets per unit time and an anticipated transaction amount per unit time.

The number of transmission packets per unit time is statistical information obtained by counting the number of packets transmitted per unit time. Unit time should be defined according to granularity of traffic control, specifically, such as in units of milliseconds, 10 milliseconds, 100 milliseconds, or seconds. Packet counts for statistics are acquired at least for each period until the flow information 331 is updated. In addition to counting packets for each period until the flow information 331 is updated, statistics counting may count every packet including a particular information element or a combination of information elements mentioned below, besides the conditions specified in the information on a flow that should be under traffic control, as information for tracking a status of packet transmission and reception. Specifically, statistics counting may count every packet including particular information with respect to each of the following: destination IP address, source IP address, protocol, signaling type, RRC Establishment Cause, equipment type of a mobile terminal, TAI, Global eNB ID, ECGI or a combination of plural conditions such as, specifically, destination IP address and signaling type.

Items of statistics obtained by counting the number of transmission packets per unit time may be other information elements that are included in a communication packet. Such an information element can be defined as an item of statistics, i.e., every packet including it should be counted. Specifically, an information element such as “Type of Service” or an information element for grouping devices and persons pertinent to packet transmission, specifically, gender information such as man/woman for grouping end users pertinent to packet transmission can be defined as an item of statistics.

A description will be provided later for a statistics counting method using an information element of the information on a flow that should be under traffic control, which is not included in a packet that is received by the control apparatus 105.

If a statistical count value, which is the number of transmission packets per unit time with regard to a flow that falls under the conditions set in the flow information 331, has become larger than the threshold for traffic control in the transmission control information 390, the control apparatus 105 performs an action specified for the traffic control type of the transmission control information 390 on a packet including the flow sorted out by using the flow information 331.

Anticipated transaction amount per unit time is statistical information obtained by weighting the number of signaling packets transmitted per unit time by a processing load and counting the processing load of a signaling destination device (node). Specifically, if an Attach Request message of NAS protocol which is prescribed by 3GPP is transmitted, the weight should be 20 transactions and a counter for anticipated transaction amount per unit time counts up 20 counts. In the control apparatus, information that maps between each type of signaling and a processing load for each signaling destination device (node) is prepared. Unit time should be defined according to granularity of traffic control, specifically, such as in units of milliseconds, 10 milliseconds, 100 milliseconds, or seconds. Statistics counting is specifically performed with respect to each of the following: destination IP address, source IP address, protocol, signaling type, RRC Establishment Cause, equipment type of a mobile terminal, TAI, Global eNB ID, ECGI or a combination of plural conditions such as, specifically, destination IP address and signaling type. Items of statistics obtained by counting the number of transmission packets per unit time may be any information element that is included in a communication packet. Specifically, an information element such as “Type of Service” or an information element for grouping devices and persons pertinent to packet transmission, specifically, gender information such as man/woman for grouping end users pertinent to packet transmission can be defined as an item of statistics, i.e., every packet including it should be counted.

### <Transmission Control Information>

With reference to FIG. 8, information elements of transmission control information are described.

Transmission control information 390 provides a threshold for traffic control and a traffic control action that should be applied to a flow that falls under the conditions specified in the flow information.

Transmission control information 390 includes the following information elements: flow ID, traffic control type, threshold for traffic control, and priority of traffic.

“Flow ID” is the identifier of a flow sorted out by the conditions specified in the flow information.

“Traffic control type” is an information element that specifies one of traffic control actions that should be performed for the flow sorted out by the conditions specified in the flow information. The traffic control actions are, for example, shaping, policing, 0 padding, changing chunk type, etc. The traffic control type is set identical to the setting of the traffic control type that is specified for the flow sorted out by the conditions specified in the flow information of the information 311 configured by maintenance personnel.

“Threshold for traffic control” is a threshold value by which traffic control should be performed for the flow sorted out by the conditions specified in the flow information. For example, 100M bits/sec., 1M packets/sec., 10K transactions/sec., etc. may be set. The threshold for traffic control is set identical to the setting of the threshold for traffic control that is specified for the flow sorted out by the conditions specified in the flow information of the information 311 configured by maintenance personnel.

“Priority of traffic” is an information element that specifies the priority of an action such as, e.g., discard priority on the flow sorted out by the conditions specified in the flow information. The priority of traffic is set identical to the setting of the priority of traffic that is specified for the flow sorted out by the conditions specified in the flow information of the information 311 configured by maintenance personnel.

### <Process for Acquiring User Information>

FIGS. 9A and 9B are sequence diagrams illustrating a process for acquiring user information.

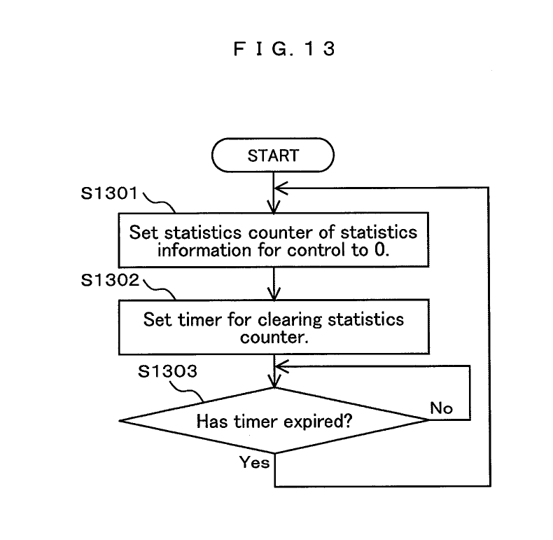

FIGS. 9A and 9B illustrate processing details for acquiring a set of IDs to be stored into the storage for user information 341 by continuing to monitor messages transmitted and received between devices (nodes), triggered by receiving an “Attach Request” included an “Initial UE Message” which is transmitted by user equipment to initially connect to an LTE network, which is prescribed by 3GPP. A first half phase of the process is illustrated in FIG. 9A and its second half phase is illustrated in FIG. 9B separately. Upon acquiring user information, if information has already been stored in a set of user information 341 into which the acquired information should be stored, the control apparatus 105 overwrites the existing information. Upon acquiring information, if a set of user information 341 into which the acquired information should be stored does not exist, the control apparatus 105 generates a new set of user information 341. Although the control apparatus 105 performs a traffic control action if a received packet should be under traffic control, a description is provided here with FIGS. 9A and 9B assuming that a received packet should not be under traffic control. Concrete traffic control procedures will be described with FIG. 13 and subsequent figures. Messages that are transmitted and received between each device (node), namely, eNB 101, HSS 103, EIR 104, MME 106, or S-GW 107 and protocols of the messages are those which are prescribed by 3GPP.

In FIG. 9A, when the control apparatus 105 has received from an eNB 101 an “Attach Request” of NAS protocol (S901), which includes IMSI information, the control apparatus 105 generates a new set of user information 341 (S902). Also, the control apparatus 105 acquires the following information: IMSI from the “Attach Request” in the received packet; eNB UE S1AP ID from an “Initial UE Message” of S1-AP protocol in the received packet; S1-MME MME IP address from a destination IP address field in an IP header of the received packet; and S1-MME eNB IP from a source IP address field in the IP header of the received packet (S903). The control apparatus 105 stores these pieces of information into the set of user information 341 newly generated at step 901. If a value of S-TMSI is included in the “Initial UE Message” in the received packet, the control apparatus 105 also acquires the value of S-TMSI. S-TMSI is a user identifier including a MME code and M-TMSI in S1-AP protocol, which is prescribed by 3GPP. In a case where the control apparatus 105 implements area-conscious traffic control, the control apparatus 105 also acquires TAI information from the “Initial UE Message” of S1-AP protocol in the received packet.

In the example of user information 341 presented herein, S-TMSI is divided into MME code and M-TMSI that are stored separately; however, S-TMSI may be managed as such without being divided into MME code and M-TMSI. It is unnecessary to acquire TAI information if the control apparatus 105 does not implement traffic control using area information specified.

The control apparatus 105 forwards the “Attach Request” to an appropriate MME (S904).

The control apparatus 105 acquires IMEISV information if IMEISV information is included in an “Authentication Information Request” (S911) of DIAMETER protocol in a packet received from the MME 106. Referring to IMSI information included in the “Authentication Information Request”, the apparatus stores the acquired IMEISV information into a set of user information 341 in which the same IMSI information is set (S912). In FIG. 9A, a step described in a dotted frame like step 912 means that it is optional whether or not the message includes IMEISV, as prescribed by 3GPP. The control apparatus 105 forwards the “Authentication Information Request” received from the MME 106 to an appropriate HSS 103 (S913). The control apparatus 105 forwards an “Authentication Information Response” received from the HSS 103 to the MME 106 (S921).

Upon receiving a “Downlink NAS Transfer” from the MME (931), the control apparatus 105 acquires MME UE S1AP ID information. The control apparatus 105 refers to eNB UE S1AP ID information included in the “Downlink NAS Transfer” and information of a destination IP address (equivalent to an S1-MME eNB IP address) in an IP header of the packet having the “Downlink NAS Transfer” included therein and stores the acquired MME UE S1AP ID information into a set of user information 341 in which a combination of the same eNB UE S1AP ID and S1-MME eNB IP address information is set (S932). The control apparatus 105 forwards the “Downlink NAS Transfer” received from the MME 106 to an appropriate eNB 101 (S933).

The control apparatus 105 acquires IMEISV information if IMEISV information is included in an “ME Identity Check Request” (S941) of DIAMETER protocol in a packet received from the MME 106. Referring to IMSI information included in the “ME Identity Check Request”, the apparatus stores the acquired IMEISV information into a set of user information 341 in which the same IMSI information is set. If IMSI information is not included in the “ME Identity Check Request”, the control apparatus 105 discards the acquired IMEISV information (S942). The control apparatus 105 forwards the “ME Identity Check Request” received from the MME 106 to an appropriate EIR 104 (S943).

Proceeding to FIG. 9B, when the control apparatus 105 has received from the MME 106 a “Create Session Request” of S11 protocol (S951), the control apparatus 105 acquires the following information: MME TEID for C-plane from the “Create Session Request” in the received packet; S11 MME IP address from a source IP address field in the received packet; and S11 S-GW IP address from a destination IP address field in the received packet (S952). Referring to IMSI information included in the “Create Session Request”, the apparatus stores the acquired information pieces, namely MME TEID for C-plane, S11 MME IP address, and S11 S-GW IP address, into a set of user information 341 in which the same IMSI information is set. The control apparatus 105 forwards the “Create Session Request” received from the MME 106 to an appropriate S-GW 107 (S953).

Upon receiving from the S-GW 107 a “Create Session Response” of S11 protocol (S961), the control apparatus 105 acquires information of S-GW TEID for C-plane from the “Create Session Response” in the received packet (S962). Referring to information of MME TEID for C-plane included in a GTP header of the “Create Session Response”, the apparatus stores the acquired information of S-GW TEID for C-plane into a set of user information 341 in which the same information of MME TEID for C-plane is set. The control apparatus 105 forwards the “Create Session Response” received from the S-GW 107 to the MME 106 (step S963). Upon receiving from the MME 106 an “Initial Context Setup Request” of S1-AP protocol (S971), the control apparatus 105 acquires information of S-GW TEID for U-plane from the “Initial Context Setup Request” in the received packet (S972). The control apparatus 105 refers to eNB UE S1AP ID information included in the “Initial Context Setup Request” and information of a destination IP address (equivalent to an S1-MME eNB IP address) in an IP header of the packet having the “Initial Context Setup Request” included therein and stores the acquired information of S-GW TEID for U-plane into a set of user information 341 in which a combination of the same eNB UE S1AP ID and S1-MME eNB IP address information is set. The control apparatus 105 forwards the “Initial Context Setup Request” received from the MME 106 to the eNB 101 (S973).

Upon receiving from the eNB 101 an “Initial Context Setup Response” of S1-AP protocol (S981), the control apparatus 105 acquires information of eNB TEID for U-plane from the “Initial Context Setup Response” in the received packet (S982). The control apparatus 105 refers to MME UE S1AP ID information included in the “Initial Context Setup Response” and information of a destination IP address (equivalent to an S1-MME MME IP address) in an IP header of the packet having the “Initial Context Setup Response” included therein and stores the acquired information of eNB TEID for U-plane into a set of user information 341 in which a combination of the same MME UE S1AP ID and S1-MME MME IP address information is set. The control apparatus 105 forwards the “Initial Context Setup Response” received from the eNB 101 to the MME 106 (step S983).

FIG. 10 is a sequence diagram illustrating a process for acquiring user information.

A process for acquiring S-TMSI is described with FIG. 10. S-TMSI is an identifier that cannot be acquired from “Attach Request” and subsequent signaling messages transmitted and received, described with FIGS. 9A and 9B, but S-TMSI can be acquired by detecting a particular sequence during communication.

A method for acquiring and storing a set of user information 341 from a “Service Request” process which is prescribed by 3GPP is set forth. Upon acquiring information, if information has already been stored in a set of user information 341 into which the acquired information should be stored, the apparatus overwrites the existing information. Upon acquiring information, if a set of user information 341 into which the acquired information should be stored does not exist, the control apparatus 105 generates a new set of user information 341. Although the control apparatus 105 performs a traffic control action if a received packet should be under traffic control, a description is provided here with FIG. 10 assuming that a received packet should not be under traffic control. Concrete traffic control procedures will be described with FIG. 13 and subsequent figures. Messages that are transmitted and received between each device (node), namely, eNB 101, HSS 103, EIR 104, MME 106, or S-GW 107 and protocols of the messages are those which are prescribed by 3GPP.

When the control apparatus 105 has received from an eNB 101 a “Service Request” of NAS protocol (S1001), the control apparatus 105 acquires the following information: S-TMSI and eNB UE S1AP ID from an “Initial UE Message” of S1-AP protocol in the received packet; S1-MME MME IP address from a destination IP address field in an IP header of the received packet; and S1-MME eNB IP from a source IP address field in the IP header of the received packet (S1002). In a case where the control apparatus 105 implements area-conscious traffic control, the control apparatus 105 also acquires TAI information from the “Initial UE Message” of S1-AP protocol in the received packet. It is unnecessary to acquire TAI information if the control apparatus 105 does not implement traffic control using area information specified. The control apparatus 105 forwards the “Service Request” to an appropriate MME 106 (S1003).

Upon receiving from the MME 106 an “Initial Context Setup Request” of S1-AP protocol (S1011), the control apparatus 105 acquires information of S-GW TEID for U-plane from the “Initial Context Setup Request” in the received packet (S1012). The control apparatus 105 refers to MME UE S1AP ID information included in the “Initial Context Setup Request” and information of a source IP address (equivalent to an S1-MME MME IP address) in an IP header of the packet having the “Initial Context Setup Request” included therein and stores the acquired information of S-GW TEID for U-plane into a set of user information 341 in which a combination of the same MME UE S1AP ID and S1-MME MME IP address information is set. If there is a match between a combination of eNB IP address and eNB UE S1AP ID information acquired at step 1002 and a combination of S1-MME eNB IP address and eNB UE S1AP ID information included in the “Initial Context Setup Request”, the control apparatus 105 stores the information pieces, S-TMSI, eNB UE S1AP ID, S1-MME MME IP address, and S1-MME eNB IP address acquired at step S1002 into the same set as the set of user information 341 into which it stores the information included in the “Initial Context Setup Request”. The control apparatus 105 forwards the “Initial Context Setup Request” received from the MME 106 to the appropriate eNB 101 (S1013).

Upon receiving from the eNB 101 an “Initial Context Setup Response” of S1-AP protocol (S1021), the control apparatus 105 acquires information of eNB TEID for U-plane from the “Initial Context Setup Response” in the received packet (S1022). The apparatus refers to MME UE S1AP ID information included in the “Initial Context Setup Response” and information of a destination IP address (equivalent to an S1-MME MME IP address) in an IP header of the packet having the “Initial Context Setup Response” included therein and stores the acquired information of eNB TEID for U-plane into a set of user information 341 in which a combination of the same MME UE S1AP ID and S1-MME MME IP address information is set. The control apparatus 105 forwards the “Initial Context Setup Response” received from the eNB 101 to the MME 106 (S1023).

When having received another message of NAS protocol and an “Initial UE Message” of S1-AP protocol from an eNB 101, the control apparatus 105 likewise stores information pieces, namely S-TMSI, eNB UE S1AP ID, MME UE S1AP ID, S1-MME eNB IP, and S1-MME MME IP, into a set of user information 341 in the same way as the steps S1002 and S1012.

Also for a handover process which is prescribed by 3GPP, the control apparatus 105 likewise acquires information from “Path Switch Request” of S1-AP protocol, “Path Switch Request Acknowledgement” of S1-AP protocol, “Handover Request” of S1-AP protocol, “Handover Request Acknowledgement” of S1-AP protocol, “Create Session Request” of S11 protocol, and “Create Session Response” of S11 protocol and stores the acquired information into a set of user information 341.

Also for a tracking area update process which is prescribed by 3GPP, the control apparatus 105 likewise acquires information from “Initial UE Message” of S1-AP protocol, “Downlink NAS Transfer” of S1-AP protocol, “Initial Context Setup Request” of S1-AP protocol, “Initial Context Setup Response” of S1-AP protocol, “Create Session Request” of S11 protocol, and “Create Session Response” of S11 protocol and stores the acquired information into a set of user information 341.

In a case when the control apparatus 105 has received a “Detach Request” of NAS protocol which is prescribed by 3GPP, the control apparatus 105 deletes information pieces other than IMSI, IMEISV, S1-MME MME IP address, MME MCC, MME MNC, MME Group ID, MME code, and M-TMSI among information elements stored in a set of user information 341 in which the information on the user that transmitted the “Detach Request” is stored.

In a case when the control apparatus 105 has received an “Attach Request” of NAS protocol including IMSI information which is prescribed by 3GPP and if there is a set of user information 341 having that IMSI stored therein, the control apparatus 105 deletes all information elements in the set of user information 341 for the user that transmits the “Attach Request” and generates a new set of user information 341 for the user.

### <Process for Acquiring Log Information for Control and Statistics Information for Control>

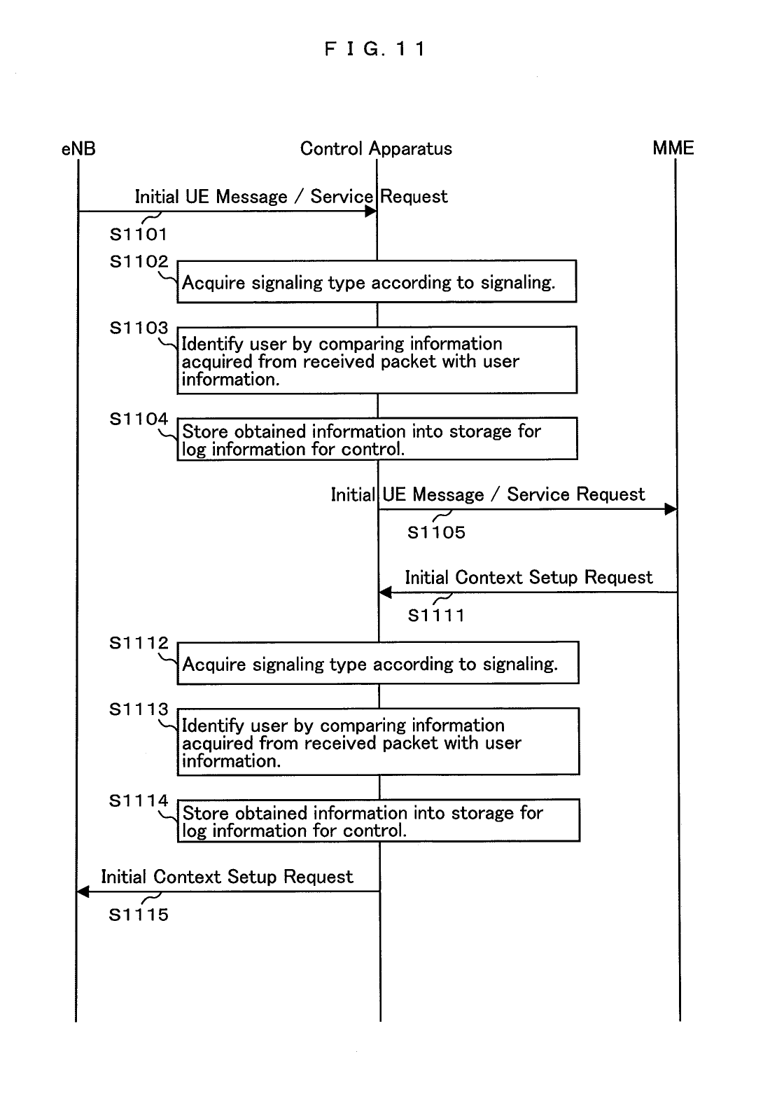

FIG. 11 is a sequence diagram illustrating the process for acquiring log information for control and statistics information for control.

Taking up an example of a “Service Request” process which is prescribed by 3GPP, the process for acquiring log information for control and statistics information for control is set forth.

Upon receiving a packet from an eNB 101 (S1101), the control apparatus 105 analyzes the received packet and acquires a signaling type (S1102). How to identify a signaling type should comply with a rule prescribed by 3GPP. In the present embodiment, the signaling type is a “Service Request” of NAS protocol. The control apparatus 105 acquires the following information: S-TMSI and eNB UE S1AP ID from an “Initial UE Message” of S1-AP protocol in the received packet; S1-MME MME IP address from a destination IP address field in a IP header of the received packet; and S1-MME eNB IP from a source IP address field in the IP header of the received packet. The control apparatus 105 uses the information pieces, namely S-TMSI and S1-MME MME IP address, acquired from the received packet, compares these data pieces with corresponding information elements in the storage of user information 341, and picks out a set of user information 341 having the same data of S-TMSI and S1-MME MME IP address. If there is a set of user information 341 having the same data of S-TMSI and S1-MME MME IP address, the control apparatus 105 acquires IMSI information from that set of user information 341 and identifies the user. If there is a set of user information 341 having the same data of S-TMSI and S1-MME MME IP address but IMSI information is not set in that set of user information 341 or if there is not a set of user information 341 having the same data of S-TMSI and S1-MME MME IP address, the control apparatus 105 identifies the user by the combination of the information pieces, S-TMSI and S1-MME MME IP address (S1103). The control apparatus 105 stores information, namely, the signaling type and the information identifying the user, i.e., in the present embodiment, the IMSI information or the combination of the information pieces, S-TMSI and S1-MME MME IP address into the storage for log information 380 for control (S1104). The control apparatus 105 forwards the “Service Request” to an appropriate MME 106 (S1105).

Upon receiving a packet from the MME 106 (S1111), the control apparatus 105 analyzes the received packet and acquires a signaling type (S1112). How to identify a signaling type should comply with a rule prescribed by 3GPP. In the present embodiment, the signaling type is an “Initial Context Setup Request”. The control apparatus 105 acquires the following information: eNB UE S1AP ID and MME UE S1AP ID from the “Initial Context Setup Request” of S1-AP protocol in the received packet; S1-MME eNB IP address from a destination IP address field in a IP header of the received packet; and S1-MME MME IP from a source IP address field in the IP header of the received packet.

If, at step 1103, the control apparatus 105 identified the user by the combination of the information pieces, namely S-TMSI and S1-MME MME IP address, the control apparatus 105 uses the information pieces, MME UE S1AP ID and S1-MME MME IP address, acquired from the “Initial Context Setup Request”, compares these data pieces with corresponding information elements in the storage of user information 341, and picks out a set of user information 341 having the same data of MME UE S1AP ID and S1-MME MME IP address. If there is a set of user information 341 having the same data of MME UE S1AP ID and S1-MME MME IP address, the control apparatus 105 acquires IMSI information from that set of user information 341 and identifies the user (S1113). If the IMSI information is acquired successfully, the control apparatus 105 replaces the combination of the information pieces, namely S-TMSI and S1-MME MME IP address, which is stored at step S1104, by the IMSI information (step S1114). The control apparatus 105 forwards the “Initial Context Setup Request” to the eNB 101 (S1115). Following sequences are omitted.

### <Process for Identifying an Application>

FIG. 12 is a sequence diagram illustrating a process for identifying a user engaged in transmitting/receiving user data and associating an application being executed by the user with the user.

FIG. 12 illustrates an example of a process in which the control apparatus 105 analyzes user data being transmitted/received between an eNB 101 and an S-GW 107, identifies a user engaged in transmitting/receiving the user data, identifies an application being transmitted/received, and, for management, associates an executed application with a signaling process such as “Service Request” initiated by the user for user data transmission.

Upon receiving from an eNB 101 a GTP-U packet of GTP protocol (S1201), the control apparatus 105 acquires the following information: S-GW TEID for U-plane from TEID information in a GTP header of GTP protocol in the received packet; and S1-U S-GW IP address from a destination IP address field in an IP header of the received packet. The control apparatus 105 identifies the user by comparing the acquired information pieces with user information 341 and searching for a set of user information 341 having the same data of S-GW TEID for U-plane and S-GW IP address (S1202). GTP-U is a message of GTP protocol which is used to transfer user data, as prescribed by 3GPP. The control apparatus 105 acquires L7 (Layer 7) information in order to analyze an application (S1203). The control apparatus 105 forwards the GTP-U received from the eNB 101 to an appropriate S-GW 107 (S1204).

Upon receiving from the S-GW 107 a GTP-U packet of GTP protocol (S1211), the control apparatus 105 acquires the following information: eNB TEID for U-plane from TEID information in a GTP header of GTP protocol in the received packet; and S1-U eNB IP address from a destination IP address field in an IP header of the received packet. The control apparatus 105 identifies the user by comparing these data pieces with user information 341 and searching for a set of user information 341 having the same data of eNB TEID for U-plane and eNB IP address (S1212). The control apparatus 105 acquires L7 (Layer 7) information in order to analyze an application (S1213). The control apparatus 105 forwards the GTP-I received from the S-GW 107 to the eNB 101 (S1214).

The application analyzer 350 in the control apparatus 105 compares L7 information acquired at step 1203 and step 1213 with “Signature” information of applications and identifies an application from protocol information included in L7 and information on packets which have been transmitted and received (S1221). The control apparatus 105 creates and stores information associating the identified application with the user that executes the application into the storage for log information 380 for control (S1222).

### <Process for Controlling a Counter for Statistics Information for Traffic Control>

FIG. 13 is a flowchart illustrating a process for clearing a statistics counter for statistics information for control by which the apparatus determines whether a traffic control action should be performed.

The traffic management unit 310 in the control apparatus 105 clears a statistics counter for statistics information 381 for control to 0 at the time of startup of the apparatus (S1301). Also, the traffic management unit 310 in the control apparatus sets a timer for clearing the statistics counter for statistics information 381 for control (S1302). The apparatus may have different timers for respective statistics counters to clear the statistics counters for statistics information 381 for control. When the timer for clearing the statistics counter for statistics information 381 for control has expired (S1303), the traffic management unit 310 in the control apparatus resets the statistic counter for statistics information 381 for control to 0 (S1301) and sets the timer for clearing the statistics counter for statistics information 381 for control again (S1302).

### <Traffic Control Processes>

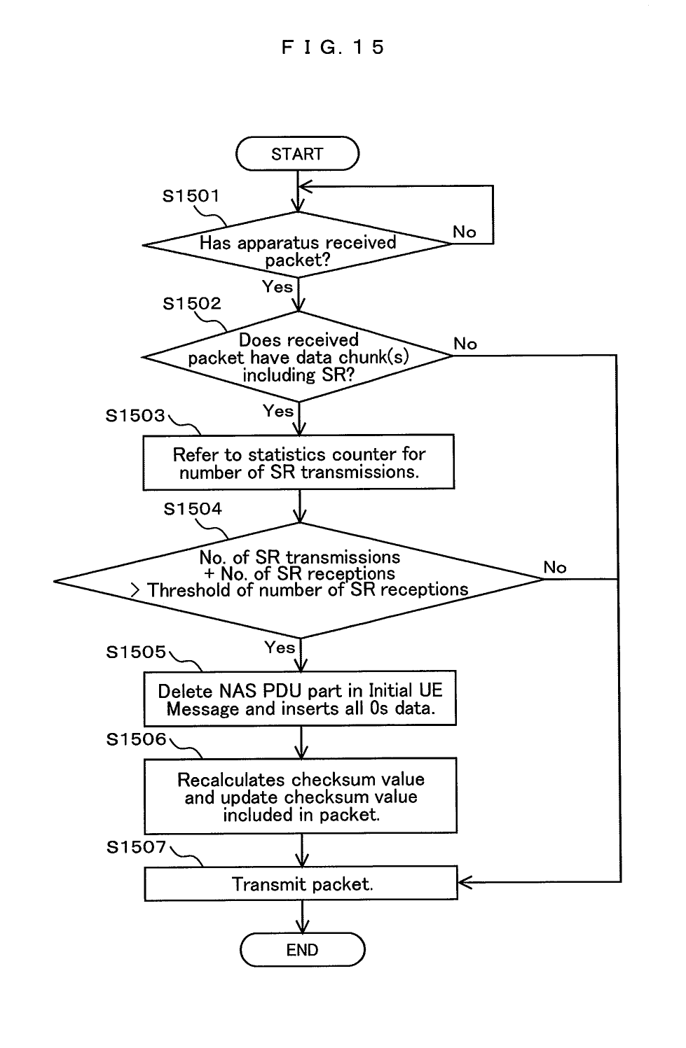

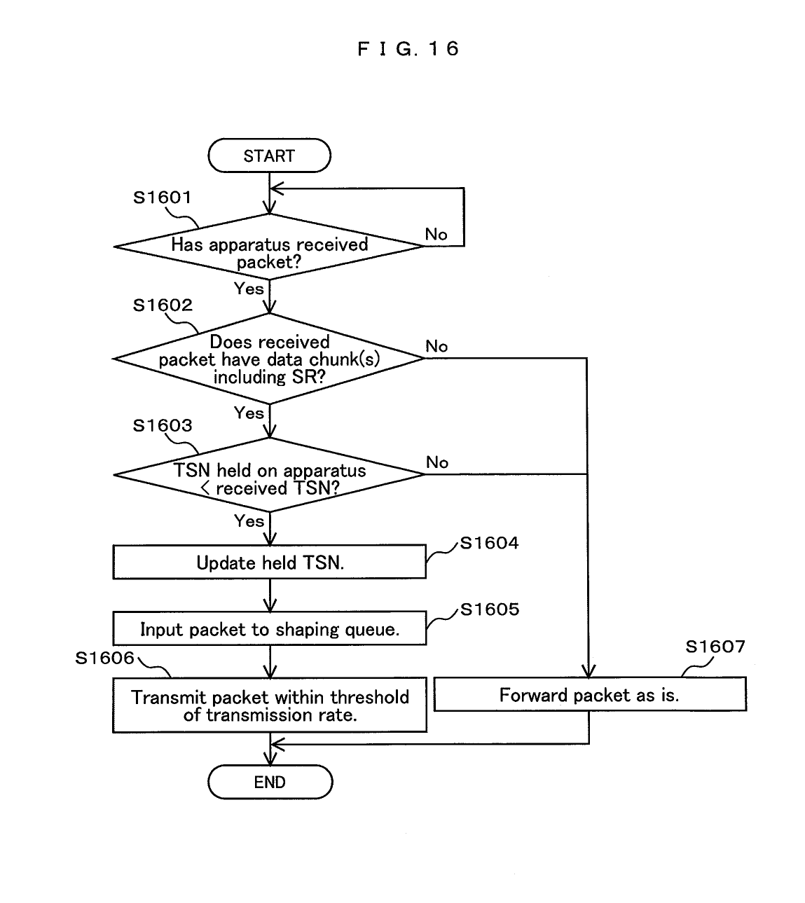

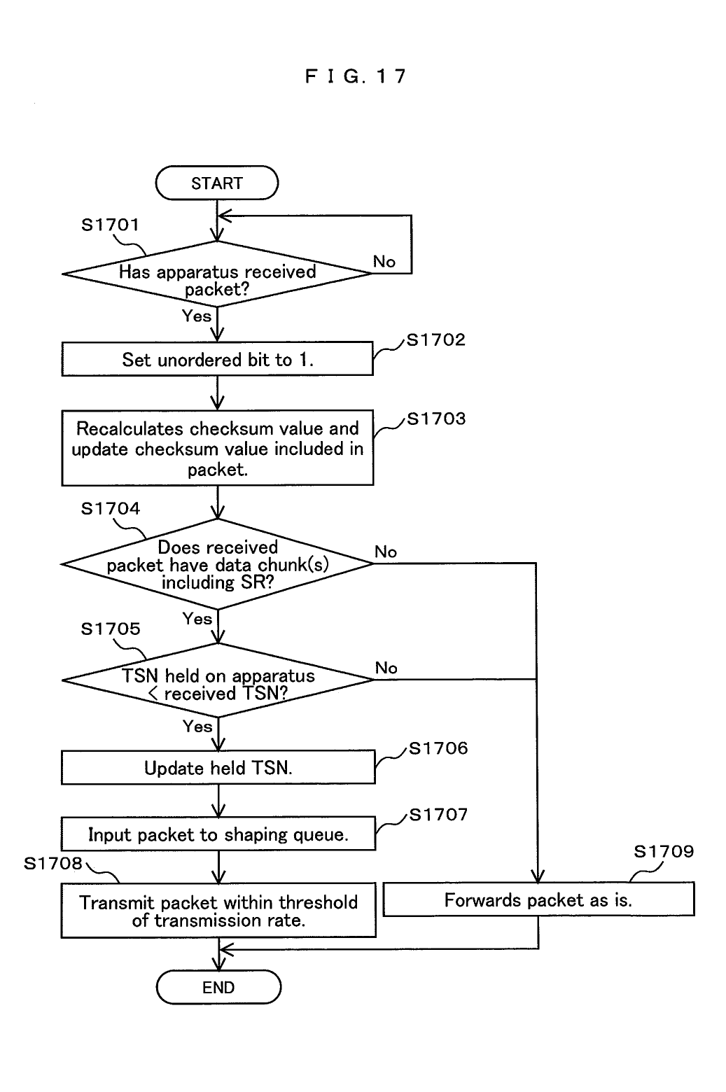

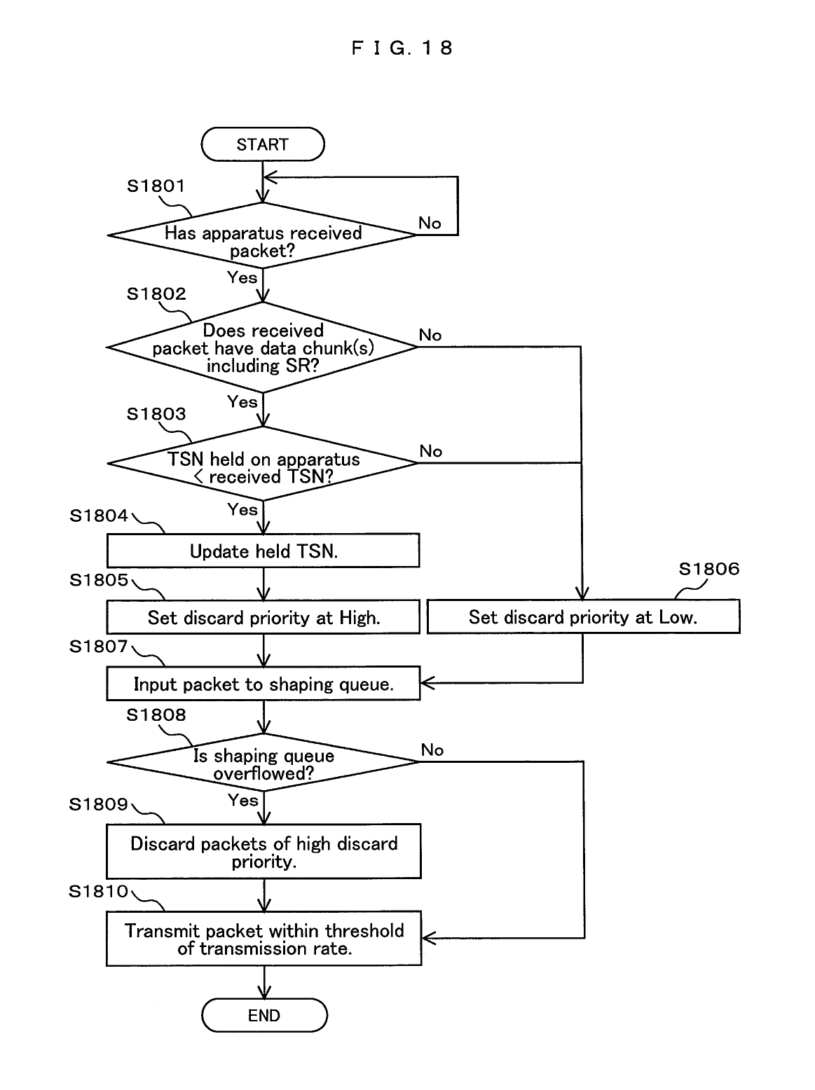

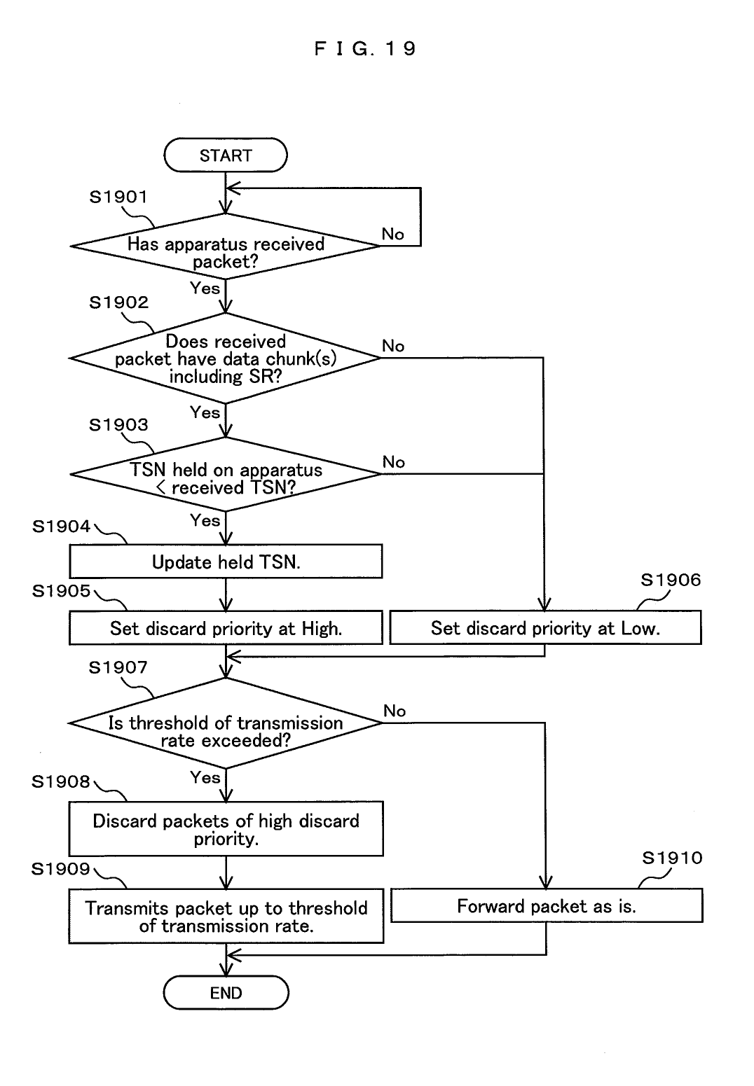

Using FIGS. 14 to 19, descriptions are provided for a plurality of types of traffic control actions that are performed in the present embodiment. FIGS. 14 and 15 illustrate a traffic control action by packet editing. FIGS. 16 and 17 illustrate a traffic control action by shaping. FIG. 18 illustrates a traffic control action by shaping overall packet transmissions. FIG. 19 illustrates a traffic control action by packet discard control.

FIG. 14 is a flowchart illustrating an example of a procedure for a traffic control action using chunk type.

The following sets forth an example of a traffic control action in a case where “Service Request” which is prescribed by 3GPP is set for the signaling type for which traffic control should be performed in the flow information 331 and an action “Set 190 for chunk type” is set for the traffic control type in the transmission control information 390. Traffic control according to signaling type and on a per-user basis can also be implemented by setting information elements of the flow information 331 as follows: “Service Request” which is prescribed by 3GPP for the signaling type; S1-MME MME IP address of an MME that should be under traffic control for the destination IP address; and S-TMSI assigned to the user of a mobile terminal that should be under traffic control for an S-TMSI parameter.

The traffic control apparatus 105 can perform a traffic control action on signaling transmissions occurring attributed by the run of a particular application by setting S1-MME MME IP address of an MME that should be under traffic control and setting, for an S-TMSI parameter, S1-MME MME IP address of an MME to which a mobile terminal user that executes the particular application is connecting and S-TMSI of the mobile terminal user that executes the particular application for only a time segment corresponding to an application run pattern of the mobile terminal user that executes the particular application.

The traffic control apparatus 105 can perform a traffic control action on signaling transmissions occurring attributed by the run of a particular application by setting S1-MME MME IP address of an MME that should be under traffic control and setting, for an S-TMSI parameter, S1-MME MME IP address of an MME to which the equipment type of a mobile terminal that executes the particular application is connecting and S-TMSI of a user who uses the equipment type of the mobile terminal that executes the particular application for only a time segment corresponding to an application run pattern of the equipment type of the mobile terminal that executes the particular application.

Upon receiving a packet (S1401), the control apparatus 105 refers to information in the flow information 331 and sorts out a flow for which it should perform a traffic control action. In the present embodiment, because “Service Request” which is prescribed by 3GPP is set for the signaling type in the flow information 331, the apparatus analyzes the received packet and checks whether a “Service Request” is included in the received packet. As prescribed by 3GPP, a message of NAS protocol is set as a message of S1-AP protocol and a message of S1-AP protocol is transmitted over a Stream Control Transmission Protocol (SCTP). Since it is prescribed by Request For Comment (RFC) that a packet of SCTP protocol has a packet structure in which a plurality of chunks can be included in one packet of SCTP protocol, there is a possibility that a plurality of messages of S1-AP protocol are included in the received packet. The control apparatus 105 checks all chunks in the received packet and checks to see whether a “Service Request” is included in the received packet (S1402).

If one or more “Service Requests” are included in the received packet, the control apparatus 105 refers to a statistics counter counting the number of “Service Request” transmissions per unit time for statistics information 381 for control (S1403).

If the sum of the value of the counter counting the number of “Service Request” transmissions per unit time for statistics information 381 for control and the number or size of “Service Requests” included in the received packet is larger than the appropriate threshold for traffic control in the transmission control information 390 (S1404), the control apparatus 105 performs a traffic control action set for the traffic control type in the transmission control information 390 on “Service Request(s)” in excess of the threshold for traffic control in the transmission control information 390. Because, in the present embodiment, an action “set 190 for chunk type” is set for the traffic control type in the transmission control information 390, the control apparatus 105 sets “190” for the chunk type of a data chunk including “Service Request” as many as the number of “Service Requests” more than the threshold for traffic control in the transmission control information 390 (S1405). “Chunk type 190” is a reserve value which is normally unassigned for practical use and a device (node) that receives a chunk set to “chunk type 190” skips the chunk and continues packet receive processing according to a standard operation rule. Then, the apparatus recalculates a checksum value and updates the checksum value included in the received packet. For the packet with one or more data chunks for which “190” is set for chunk type, the apparatus recalculates its Frame Check Sequence number and updates the Frame Check Sequence number included in the received packet (S1406).

If no “Service Request” is included in the received packet, found by the check at step 1402, the control apparatus 105 makes no change to information in the packet and forwards the received packet according to the destination IP address included in the received packet. If, at step 1404, the sum of the value of the counter counting the number of “Service Request” transmissions per unit time for statistics information 381 for control and the number or size of “Service Requests” included in the received packet is less than or equal to the appropriate threshold for traffic control in the transmission control information 390, the control apparatus 105 makes no change to information in the received packet and the packet structure and forwards the received packet according to the destination IP address included in the received packet. If, at step S1404, the sum of the value of the counter counting the number of “Service Request” transmissions per unit time for statistics information 381 for control and the number or size of “Service Requests” included in the received packet is larger than the appropriate threshold for traffic control in the transmission control information 390, the control apparatus 105 forwards the received packet subjected to the processing in the steps 1405 and 1406 according to the destination IP address included in the received packet (S1407).

FIG. 15 is a flowchart illustrating an example of a procedure for a traffic control action using a chunk's payload part.

The following sets forth an example of a traffic control action in a case where “Service Request” which is prescribed by 3GPP is set for the signaling type for which traffic control should be performed in the flow information 331 and an action “Delete a NAS PDU part within an “Initial UE Message” and insert all 0s data” is set for the traffic control type in the transmission control information 390. Although an example of a control action of deleting a NAS PDU part within an “Initial UE Message” is set forth in the present embodiment, a control action may delete an “Initial UE Message”. Alternatively, all 0s data may be replaced by bit string data that is judged invalid at a device (node) with a destination IP address to which the packet is forwarded. Alternatively, a data chunk including an “Initial UE Message” may be deleted from the packet. Processing in step 1501 is the same as processing in the foregoing step 1401. Processing in step 1502 is the same as processing in the foregoing step 1402. Processing in step 1503 is the same as processing in the foregoing step 1403. Processing in step 1504 is the same as processing in the foregoing step 1404.

The control apparatus 105 performs a traffic control action set for the traffic control type in the transmission control information 390 on “Service Request(s)” in excess of the appropriate threshold for traffic control in the transmission control information 390. Because, in the present embodiment, the action “Delete a NAS PDU part within an “Initial UE Message” and insert all 0s data” is set for the traffic control type in the transmission control information 390, control apparatus 105 deletes a NAS PDU part and inserts all 0s data within an “Initial UE Message” included in a data chunk including “Service Request” as many as the number of “Service Requests” more than the threshold for traffic control in the transmission control information 390. If the size of all 0s data inserted differs from the size of deleted NAS PDU part(s), the apparatus recalculates a Length value in each protocol within the received packet in which all 0s data is inserted and update the Length value in each protocol (S1505). The apparatus also recalculates a checksum value of the received packet in which all 0s data is inserted and updates the checksum value included in the received packet. The apparatus also recalculates a Frame Check Sequence number of the received packet in which all 0s data is inserted and updates the Frame Check Sequence number included in the received packet (S1506).

If no “Service Request” is included in the received packet, found by the check at step 1502, the control apparatus 105 makes no change to information in the packet and forwards the received packet according to the destination IP address included in the received packet. If, at step 1504, the sum of the value of the counter counting the number of “Service Request” transmissions per unit time for statistics information 381 for control and the number or size of “Service Requests” included in the received packet is less than or equal to the appropriate threshold for traffic control in the transmission control information 390, the control apparatus 105 makes no change to information in the received packet and the packet structure and forwards the received packet according to the destination IP address included in the received packet. If, at step S1504, the sum of the value of the counter counting the number of “Service Request” transmissions per unit time for statistics information 381 for control and the number or size of “Service Requests” included in the received packet is larger than the appropriate threshold for traffic control in the transmission control information 390, the control apparatus 105 forwards the received packet subjected to the processing in the steps 1505 and 1506 according to the destination IP address included in the received packet (S1507).

FIG. 16 is a flowchart illustrating an example of a procedure for a traffic control action using traffic shaping that should be applied to a particular flow.

The following sets forth an example of a traffic control action in a case where “Service Request” which is prescribed by 3GPP is set for the signaling type for which traffic control should be performed in the flow information 331 and “shaping” is set for the traffic control type in the transmission control information 390. Processing in step 1601 is the same as processing in the foregoing step 1401. Processing in step 1602 is the same as processing in the foregoing step 1402.

The control apparatus 105 compares a Transmission Sequence Number (TSN) included in a data chunk in the received packet with TSN held on the control apparatus 105. Upon the startup of the control apparatus 105, TSN held on the control apparatus 105 should be 0. As a result of comparing TSN included in a data chunk in the received packet with TSN held on the control apparatus 105, if the TSN included in a data chunk in the received packet is larger, the control apparatus 105 sorts out the packet as the one to be subjected to shaping. By this processing, when packet transfer sequence is controlled by SCTP protocol, it is possible to exclude a retransmission packet from packets that should be under traffic control. Although an example of a case where retransmission packets are exempted from traffic control is set forth in the present embodiment, it is also possible to include some of retransmission packets in packets that should be under traffic control by using a conditional expression for decision “TSN held−α<received TSN?” and adjusting a value of α (S1603).

As a result of comparing TSN included in a data chunk in the received packet with TSN held on the control apparatus 105, if the TSN included in a data chunk in the received packet is larger, the control apparatus 105 updates the TSN held on the control apparatus 105 to the TSN included in a data chunk in the received packet (S1604).

As a result of comparing TSN included in a data chunk in the received packet with TSN held on the control apparatus 105, if the TSN included in a data chunk in the received packet is larger, the control apparatus 105 inputs the received packet to the shaping queue (S1605).

The control apparatus 105 refers to information on the threshold for traffic control in the transmission control information 390 and transmits the packet(s) inputted to the shaping queue according to a transmission rate set for a threshold value for traffic control in the transmission control information 390 (S1606).

If no “Service Request” is included in the received packet, found by the check at step 1602, the control apparatus 105 makes no change to information in the packet and forwards the received packet according to the destination IP address included in the received packet. At step 1603, as a result of comparing TSN included in a data chunk in the received packet with TSN held on the control apparatus 105, if the TSN included in a data chunk in the received packet is the same number or smaller, the control apparatus 105 makes no change to information in the received packet and the packet structure and forwards the received packet according to the destination IP address included in the received packet (S1607).

FIG. 17 is a flowchart illustrating an example of a procedure for a traffic control action using traffic shaping that should be applied to a particular flow and unordered bits.

The following sets forth an example of a traffic control action in a case where “Service Request” which is prescribed by 3GPP is set for the signaling type for which traffic control should be performed in the flow information 331 and an action “shaping and set unordered bits to 1” is set for the traffic control type in the transmission control information 390.

Upon receiving a packet (S1701), the control apparatus 105 sets unordered bits included in chunks in the received packet to 1. By this processing, at a device (node) with a destination IP address in the received packet, to which the packet is forwarded, when receiving a SCTP packet with a non-serial TSN, it is possible to transfer data in the SCTP packet to a higher layer without waiting for a retransmission of SCTP protocol (S1702).

If the apparatus changes the values of unordered bits, the control apparatus 105 recalculates a checksum value of the packet in which the values of unordered bits are changed and updates the checksum value included in the received packet. The apparatus also recalculates a Frame Check Sequence number of the packet in which the values of unordered bits are changed and updates the Frame Check Sequence number included in the received packet. Processing in step 1704 is the same as processing in the foregoing step 1402. Processing in step 1705 is the same as processing in the foregoing step 1603. Processing in step 1706 is the same as processing in the foregoing step 1604. Processing in step 1707 is the same as processing in the foregoing step 1605. Processing in step 1708 is the same as processing in the foregoing step 1606. Processing in step 1709 is the same as processing in the foregoing step 1607.

FIG. 18 is a flowchart illustrating an example of a procedure for a traffic control action using traffic shaping that should be applied to all received packets.

The following sets forth an example of a traffic control action in a case where “Service Request” which is prescribed by 3GPP is set for the signaling type for which traffic control should be performed in the flow information 331 and an action “shaping all received packets” is set for the traffic control type in the transmission control information 390. Although two levels of discard priority, high and low, are assumed in the present embodiment, more than two levels of discard priority may be set to control traffic if a larger number of flows has to be sorted. Processing in step 1801 is the same as processing in the foregoing step 1401. Processing in step 1802 is the same as processing in the foregoing step 1402. Processing in step 1803 is the same as processing in the foregoing step 1603. Processing in step 1804 is the same as processing in the foregoing step 1604.

As a result of comparing TSN included in a data chunk in the received packet with TSN held on the control apparatus 105, if the TSN included in a data chunk in the received packet is larger, the control apparatus 105 sets the discard priority of the packet at high (S1805).

If no “Service Request” is included in the received packet, found by the check at step 1802, the control apparatus 105 sets the discard priority of the packet at low. As a result of comparing TSN included in a data chunk in the received packet with TSN held on the control apparatus 105, if the TSN included in a data chunk in the received packet is the same number or smaller, the control apparatus 105 sets the discard priority of the packet at low. In the present embodiment, an example is set forth in which the discard priority to be set in a case where no “Service Request” is included in the received packet and the discard priority to be set in a case where the TSN included in a data chunk in the received packet is the same number or smaller as a result of comparing TSN included in a data chunk in the received packet with TSN held on the control apparatus 105 are the same low level; however, different levels of discard priority may be set for each of these cases (S1806).

The control apparatus 105 inputs all received packets to the shaping queue (S1807). If packets staying in the shaping queue have overflowed (S1808), the control apparatus 105 preferentially discards packets of high discard priority (S1809). The control apparatus 105 refers to information on the threshold for traffic control in the transmission control information 390 and transmits packets inputted to the shaping queue according to a transmission rate set for a threshold value for traffic control in the transmission control information 390 (S1810).

FIG. 19 is a flowchart illustrating an example of a procedure for a traffic control action using traffic policing.

The following sets forth an example of a traffic control action in a case where “Service Request” which is prescribed by 3GPP is set for the signaling type for which traffic control should be performed in the flow information 331 and “policing” is set for the traffic control type in the transmission control information 390. Although two levels of discard priority, high and low, are assumed in the present embodiment, more than two levels of discard priority may be set to control traffic if a larger number of flows has to be sorted. Processing in step 1901 is the same as processing in the foregoing step 1401. Processing in step 1902 is the same as processing in the foregoing step 1402. Processing in step 1903 is the same as processing in the foregoing step 1603. Processing in step 1904 is the same as processing in the foregoing step 1604. Processing in step 1905 is the same as processing in the foregoing step 1805. Processing in step 1906 is the same as processing in the foregoing step 1806.

By referring to the threshold for traffic control in the transmission control information 390, if the apparatus receives an amount of packets in excess of a transmission rate set for a threshold value for traffic control in the transmission control information 390 (S1907), the control apparatus 105 preferentially discards packets of high discard priority (S1908).

The control apparatus 105 refers to information on the threshold for traffic control in the transmission control information 390 and transmits packets according to the transmission rate set for a threshold value for traffic control in the transmission control information 390 (S1909). If the control apparatus 105 receives an amount of packets less than the transmission rate set for a threshold value for traffic control in the transmission control information 390 (S1907), the control apparatus 105 makes no change to information in the received packet and the packet structure and forwards the received packet according to the destination IP address included in the received packet (S1910).

### <Traffic Control Based on Transaction Amount>

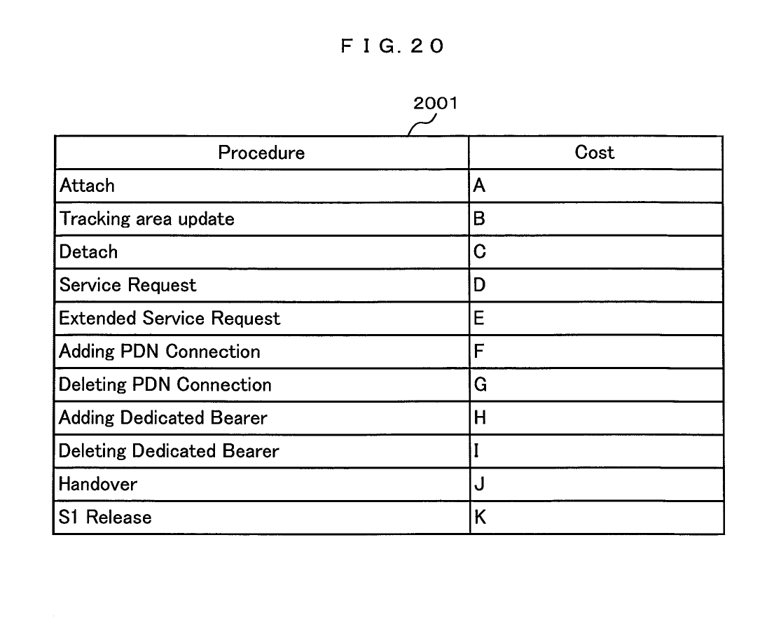

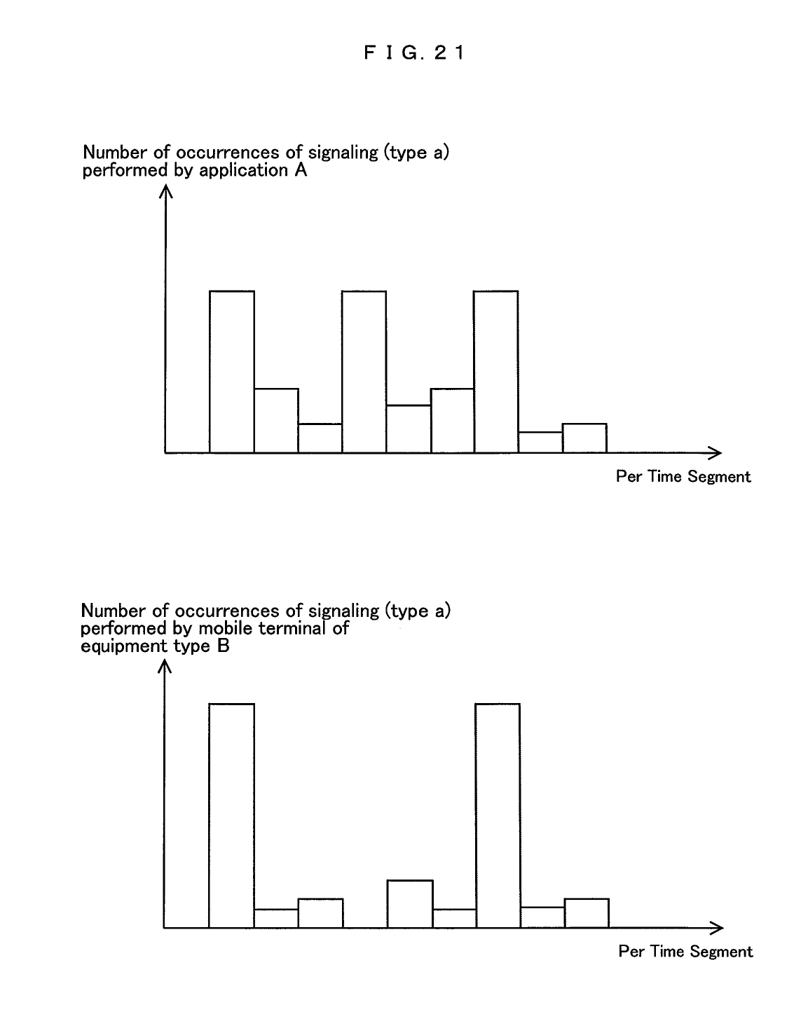

FIG. 20 presents an example of information elements that are used to acquire an anticipated transaction amount per unit time for statistics information for control.

FIG. 20 is a table that defines costs (coefficients) for calculating the amount of transactions at MME 106 to complete each signaling process. Here, processing costs are defined for, for example, the following processes which are prescribed by 3GPP: attach, tracking area update, detach, service request, extended service request, adding a PDN connection, deleting a PDN connection, adding a dedicated bearer, deleting a dedicated bearer, handover, and S1 release. For example, a definition is such that the cost of transactions A is required for MME 106 to complete an attach process. These costs of transactions are defined for each device (node) to which signaling data is transmitted.

Upon receiving a first message destined for MME 106 for a process which is prescribed by 3GPP, if the sum of the value of a statistics counter of anticipated transaction amount per unit time for statistics information 381 for control and the cost of the process relevant to the first message destined for MME 106 for a process which is prescribed by 3GPP is larger than a threshold value for traffic control in the transmission control information 390, the control apparatus 105 performs a traffic control action according to information set in the transmission control information 390 and by an appropriate one of the procedures described previously.

### <Process for Predicting Signaling Burst>

FIG. 21 is a diagram to explain about application startup prediction.

FIG. 21 is an explanatory diagram that presents information for predicting a phenomenon in which one application starts to run on a plurality of mobile terminals in one time segment and signaling processes for mobile communication occur simultaneously.

The control apparatus 105 aggregates the number of occurrences of mobile communication signaling processes, per application, for each time segment. The control apparatus 105 also aggregates the number of occurrences of mobile communication signaling processes, per equipment type of a mobile terminal, for each time segment. The control apparatus 105 analyzes a pattern of variation in the number of occurrences of mobile communication signaling processes, per application, for each time segment and then predicts a time segment during which the number of occurrences of mobile communication signaling processes per application will increase significantly.

The control apparatus 105 also analyzes a pattern of variation in the number of occurrences of mobile communication signaling processes, per equipment type of a mobile terminal, for each time segment and then predicts a time segment during which the number of occurrences of mobile communication signaling processes per equipment type of a mobile terminal will increase significantly. To predict a time segment during which the number of occurrences of mobile communication signaling processes per application will increase secondly or the number of occurrences of mobile communication signaling processes per equipment type of a mobile terminal will increase secondly, the control apparatus 105 uses the following parameters: year, month, day, a day of week, hour, minute, second, kind of holiday, area, season, or a combination of these parameters. Among these parameters, the control apparatus 105 uses a parameter for prediction according to order in which the number of mobile communication signaling processes is assumed to increase in shorter cycles and feeds back resulting information to enhance accuracy of prediction.

Specifically, the control apparatus 105 first uses information relevant to a second during which mobile communication signaling processes frequently occur and checks to see whether mobile communication signaling processes frequently occur for a corresponding second that follows. If mobile communication signaling processes frequently occur for the corresponding second that follows, the control apparatus 105 predicts that mobile communication signaling processes frequently occur in second cycles and starts traffic control in second cycles on mobile terminal users that use the relevant application or equipment type of mobile terminal. Unless mobile communication signaling processes frequently occur for the corresponding second that follows, the control apparatus 105 uses information relevant to a minute during which mobile communication signaling processes frequently occur and checks to see whether mobile communication signaling processes frequently occur for a corresponding minute and seconds that follows. Likewise, the apparatus predicts signaling occurrence in order of hour, day, a day of week, month, season, and year, checks resulting data to see whether a prediction coincides with a signal burst occurrence, and feeds back the result to traffic control.

Events or the like may lead to frequent occurrences of mobile communication signaling processes at random times. Taking this fact into consideration, information such as a schedule of yearly fireworks events or a schedule of events to happen for a time when online game participants tend to increase should be input beforehand. By inputting event information, it is also possible to predict signaling bursts to occur at random times in addition to predicting signaling bursts to occur periodically in order of second, minute, hour, day, a day of week, month, season, and year, as described above.

If the number of occurrences of mobile communication signaling processes significantly increases only in a certain area where an event or the like takes place, the apparatus may acquire TAI, ECGI, Global eNB ID, etc. that can identify the area where mobile communication signaling processes occur frequently. The control apparatus 105 may thus pick out information relevant to the area where the number of occurrences of mobile communication signaling processes significantly increases and determine whether or not to implement traffic control on a per-area basis. Also, by inputting information relevant to certain areas where events take place beforehand, the control apparatus 105 may be configured to predict an area where the number of occurrences of mobile communication signaling processes significantly increases. Also, the apparatus may be configured to calculate time-series differences in the number of occurrences of mobile communication signaling processes, per application, for each time segment, predict a tendency of increase in the number of occurrences of mobile communication signaling processes for a certain application, and automatically perform a traffic control action set for the traffic control type, if a preset threshold has been exceeded.

### Second Embodiment

Currently, there is no information element indicating an application in signaling schemes prescribed by 3GPPT. Therefore, according to the first embodiment described above, the control apparatus 105 continues to monitor signaling for initial connection of a mobile terminal to the network, collects necessary information from signaling, associates a mobile terminal with its equipment type and an application, and implements traffic control. However, if an information element that indicates an application or mobile terminal type is included in signaling, it is possible to implement traffic control taking an application into consideration more simply. A second embodiment is described below, assuming a case where an information element that indicates an application or mobile terminal type is included in signaling.

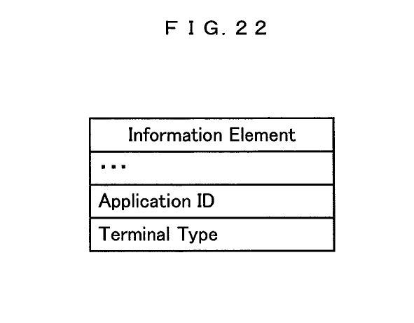

FIG. 22 is an explanatory diagram illustrating signaling in which an information element that indicates an application or mobile terminal type is added to signaling which is prescribed by 3GPP.

An information element, “application ID” for identifying an application is added to, for example, signaling of RRC (Radio Resource Control) protocol and of S1-AP protocol which are prescribed by 3GPP. An information element, “terminal type” for identifying a mobile terminal type is added to, for example, signaling of RRC protocol and of S1-AP protocol which are prescribed by 3GPP. Although it is proposed in the present embodiment that an information element is added to signaling of RRC protocol and of S1-AP protocol, the information element, “application ID” or information element, “terminal type” may be added to other protocols such as GTP and DIAMETER for implementing a mobile communication signaling process. Instead of adding a new information element, such a way of identifying an application or mobile terminal type may be used that a value that identifies an application or mobile terminal type is added as one value of an existing information element, e.g., “RRC Establishment Cause”.

Maintenance personnel specifies an application as information on a flow that should be under traffic control and gives a command to implement traffic control. The traffic management unit 310 holds information mapping between application information that is specified by the maintenance personnel and an application ID and converts the application information specified by the maintenance personnel to its corresponding “application ID”. The traffic management unit 310 sets the “application ID” information as one information element in the flow information 331. Upon receiving a packet, the traffic control apparatus 105 analyzes the packet and compares application ID information included in the received packet with application ID information which is set in the flow information 331 according to an information element set in the flow information 331 as a condition for sorting flows. If there is a match between both application IDs, the apparatus sorts the packet as a flow that should be under traffic control and performs a traffic control action, referring to information that is set in association with the flow for information elements of the transmission control information 390.

The maintenance personnel specify a mobile terminal type as information on a flow that should be under traffic control and gives a command to implement traffic control. The traffic management unit 310 holds information mapping between mobile terminal type information that is specified by the maintenance personnel and a terminal type and converts the mobile terminal type information specified by the maintenance personnel to its corresponding “terminal type”. The traffic management unit 310 sets the “terminal type” information as one information element in the flow information 331. Upon receiving a packet, the traffic control apparatus 105 analyzes the packet and compares terminal type information included in the received packet with terminal type information which is set in the flow information 331 according to information of an information element set in the flow information 331. If there is a match between both terminal types, the apparatus sorts the packet as a flow that should be under traffic control and performs a traffic control action, referring to information that is set in association with the flow for information elements of the transmission control information 390.

What is claimed is:

1. A traffic control apparatus comprising:
a packet analysis unit that analyzes a packet transmitted over a communication link;
a packet control unit that performs packet processing or packet output control; and
a traffic management unit that manages control information for controlling traffic,
wherein, with respect to a plurality of terminals that connect to a network and perform communication via the communication link, the packet analysis unit analyzes signaling during a session performed by each terminal from a time when a terminal initially connects to the network, thereby associating a terminal, an application, and signaling required for the application, and transmits analysis results to the traffic management unit,
wherein the traffic management unit generates control information including identifiers for implementing traffic control on a per-signaling basis, based on preconfigured information on an object that should be under traffic control and the analysis results,
wherein the packet analysis unit assigns to a received packet an identifier on a per-signaling basis based on the control information and transmits the packet to the packet control unit, and
wherein the packet control unit refers to the identifiers and the control information and performs a specified traffic control action on signaling included in the packet.

2. The traffic control apparatus according to claim 1,
wherein the packet analysis unit generates a new set of terminal identifier information upon receiving initial connection signaling transmitted by a terminal at a time when the terminal initially connects to the network,
wherein the packet analysis unit acquires a first terminal identifier uniquely assigned to the terminal across the network from the initial connection signaling, acquires a plurality of second terminal identifiers of the terminal, which are used for the session, from the initial connection signaling and signaling transmitted/received after initial connection during the session performed by the terminal, and stores these identifiers into the set of terminal identifier information, and
wherein the packet analysis unit analyzes an association of a terminal, an application, and signaling required for the application by analyzing signaling with reference to the first terminal identifier and the second terminal identifiers stored in the set of terminal identifier information.

3. The traffic control apparatus according to claim 2,
wherein one of the second terminal identifiers includes information pertinent to an equipment type of the terminal, and
wherein, in the traffic management unit, if a terminal equipment type is specified in the information on an object that should be under traffic control, the traffic management unit converts the terminal equipment type to the information included in the one of the second terminal identifiers and generates control information for implementing traffic control.

4. The traffic control apparatus according to claim 2, wherein if, in the traffic management unit, information for grouping terminal users by an attribute is specified in the information on an object that should be under traffic control, the traffic management unit accesses a server having users' attributes information stored herein and acquires attribute information on the user of each terminal, based on the first terminal identifier, and generates control information for implementing traffic control.

5. The traffic control apparatus according to claim 2, wherein if, in the traffic management unit, a signaling type is specified in the information on an object that should be under traffic control, the traffic management unit specifies the first terminal identifier or second terminal identifiers and the signaling type and generates control information for implementing traffic control.

6. The traffic control apparatus according to claim 2, wherein, in the traffic management unit, the information on an object that should be under traffic control includes a specified setting of at least any one of application, terminal equipment type, destination address, source address, protocol, signaling type, the first terminal identifier, and the second terminal identifiers, and the traffic management unit generates control information with the specified setting stored therein for implementing traffic control.

7. The traffic control apparatus according to claim 2, wherein an identifier that identifies an area where the terminal exists is included in the second identifiers, and
wherein if, in the traffic management unit, an area is specified as the information on an object that should be under traffic control, the traffic management unit generates control information with the identifier identifying the area stored therein for implementing traffic control.

8. The traffic control apparatus according to claim 1,
wherein the packet control unit performs any of traffic control actions as follows: packet editing that controls traffic by changing data of signaling, which is specified signaling, within a packet; discarding signaling data in excess of a threshold value; control according to a packet transmission rate; and priority control based on priority information.

9. The traffic control apparatus according to claim 1,
wherein the traffic management unit performs statistical processing with regard to an amount of signaling occurrences by associating packet analysis results received from the packet analysis unit with temporal information, and
wherein the traffic management unit predicts signaling bursts to occur at random times or periodically, based on statistical processing results, and generates the control information.

10. The traffic control apparatus according to claim 1,
wherein the packet analysis unit has a table mapping between each signaling process and an amount of load on a destination device to which a packet is transmitted for calculating an amount of load on the destination device to complete a signaling process on signaling data included in a packet, for each destination device,
wherein, upon receiving a packet, the packet analysis unit refers to the table and obtains an amount of load on a destination device for processing the packet, if transmitted to the destination device, and notifies the traffic management unit of the obtained amount of load, and
wherein the traffic management unit generates control information based on the amount of load on the destination device.

11. A traffic control method that analyzes a packet transmitted over a communication link and controls traffic based on analysis results, the traffic control method comprising:
with respect to a plurality of terminals that connect to a network and perform communication via the communication link, analyzing signaling during a session performed by each terminal from a time when a terminal initially connects to the network, thereby associating a terminal, an application, and signaling required for the application;
generating control information including identifiers for implementing traffic control on a per-signaling basis, based on preconfigured information on an object that should be under traffic control and the analysis results;
assigning to a received packet an identifier on a per-signaling basis based on the control information; and
referring to the identifiers and the control information and performing a specified traffic control action on signaling included in the packet.

12. The traffic control method according to claim 11, further comprising:
generating a new set of terminal identifier information upon receiving signaling (initial connection signaling) transmitted by a terminal at a time when the terminal initially connects to the network;
acquiring a first terminal identifier uniquely assigned to the terminal across the network from the initial connection signaling, acquiring a plurality of second terminal identifiers of the terminal, which are used for the session, from the initial connection signaling and signaling transmitted/received after initial connection during the session performed by the terminal, and storing these identifiers into the set of terminal identifier information; and
analyzing an association of a terminal, an application, and signaling required for the application by analyzing signaling with reference to the first terminal identifier and the second terminal identifiers stored in the set of terminal identifier information.

13. The traffic control method according to claim 12,
wherein one of the second terminal identifiers includes information pertinent to an equipment type of the terminal, and
wherein the traffic control method further includes, if a terminal equipment type is specified in the information on an object that should be under traffic control, converting the terminal equipment type to the information included in the one of the second terminal identifiers and generating control information for implementing traffic control.

14. The traffic control method according to claim 12, further comprising:
if information for grouping terminal users by an attribute is specified in the information on an object that should be under traffic control, accessing a server having users' attribute information stored herein and acquiring attribute information on the user of each terminal, based on the first terminal identifier, and generating control information for implementing traffic control.

15. The traffic control method according to claim 12, further comprising:
if a signaling type is specified in the information on an object that should be under traffic control, specifying the first terminal identifier or second terminal identifiers and the signaling type and generating control information for implementing traffic control.

16. The traffic control method according to claim 12, further comprising:
as the information on an object that should be under traffic control, specifying a setting of at least any one of application, terminal equipment type, destination address, source address, protocol, signaling type, the first terminal identifier, and the second terminal identifiers, and generating control information with the specified setting stored therein for implementing traffic control.

17. The traffic control method according to claim 12,
wherein an identifier that identifiers an area where the terminal exists is included in the second identifiers, and
wherein the traffic control method further comprises, if an area is specified as the information on an object that should be under traffic control, generating control information with the identifier identifying the area stored therein for implementing traffic control.

18. The traffic control method according to claim 11, further comprising:
performing any of traffic control actions as follows: packet editing that controls traffic by changing data of signaling, which is specified signaling, within a packet; discarding signaling data in excess of a threshold value; control according to a packet transmission rate; and priority control based on priority information.

19. The traffic control method according to claim 11, further comprising:
performing statistical processing with regard to an amount of signaling occurrences by associating the packet analysis results with temporal information; and
predicting signaling bursts to occur at random times or periodically, based on statistical processing results, and generating the control information.

20. The traffic control method according to claim 11, further comprising:
maintaining a table mapping between each signaling process and an amount of load on a destination device to which a packet is transmitted for calculating an amount of load on the destination device to complete a signaling process on signaling data included in a packet, for each destination device;
upon receiving a packet, referring to the table and obtaining an amount of load on a destination device for processing the packet, if transmitted to the destination device; and
generating control information based on the amount of load on the destination device.
